(19) United States
(12) Patent Application Publication
(10) Pub. No.: US 2025/0168783 A1
(43) Pub. Date: May 22, 2025

(54) POWER CONTROL FOR SIMULTANEOUS PHYSICAL UPLINK SHARED CHANNEL (PUSCH) TRANSMISSION IN A CELL

(71) Applicant: Lenovo (Beijing) Limited, Beijing (CN)

(72) Inventors: Bingchao Liu, Beijing (CN); Chenxi Zhu, Beijing (CN); Lingling Xiao, Beijing (CN); Wei Ling, Beijing (CN); Yi Zhang, Beijing (CN)

(73) Assignee: Lenovo (Beijing) Limited, Beijing (CN)

(21) Appl. No.: 18/841,136

(22) PCT Filed: Apr. 22, 2022
(86) PCT No.: PCT/CN2022/088452

§ 371 Date: Aug. 23, 2024

(51) Int. Cl. H04W 52/36; H04W 72/1268; H04W 72/231; H04W 76/20

(52) U.S. Cl. CPC H04W 52/367; H04W 52/365; H04W 72/1268; H04W 72/231; H04W 76/20

(57) ABSTRACT

Methods and apparatuses for power control for simultaneous PUSCH transmission in a cell are disclosed. In one embodiment, a UE comprises a transceiver; and a processor coupled to the transceiver, wherein the processor is configured to transmit, via the transceiver, a configuration to configure one or multiple maximum output power values for a serving cell (c) and at least one of a first DCI associated with a first coresetPoolIndex value and a second DCI associated with a second coresetPoolIndex value different from the first coresetPoolIndex value, in a BWP (b) of a carrier (f) of the serving cell (c), the first DCI schedules a first PUSCH transmission associated with the first coresetPoolIndex value and the second DCI schedules a second PUSCH transmission associated with the second coresetPoolIndex value, the first PUSCH transmission and the second PUSCH transmission are in one slot; and receive, via the transceiver, at least one of the first PUSCH transmission and the second PUSCH transmission.

### FIELD

The subject matter disclosed herein generally relates to wireless communications, and more particularly relates to methods and apparatuses for power control for simultaneous PUSCH transmission in a cell.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Physical Uplink Control Channel (PUCCH), Physical Uplink Shared Channel (PUSCH), Sounding Reference Signal (SRS), Downlink Control Information (DCI), (CC), transmission reception point (TRP), control resource set (CORESET), Transmission Configuration Indicator (TCI), radio frequency (RF), Phase Locked Loop (PLL), Physical Downlink Control Channel (PDCCH), Transport Block (TB), Pathloss reference signal (PL-RS), Power headroom (PH), uplink shared channel (UL-SCH), power headroom report (PHR), band width part (BWP), Power Amplifier (PA), Phase Locked Loop (PLL).

Panel-selection based UL transmission was specified in NR Release 17 for a UE equipped with multiple panels which can be used for UL transmission. A UE may be equipped with multiple panels, while only one panel can be used for UL transmission at a time instant in NR Release 17 due to power limitation. It means that only one PUSCH transmission or one PUCCH resource or one SRS resource can be scheduled to be transmitted at a time instant in a carrier using one panel.

Advanced UEs can benefit from higher UL coverage and average throughput with simultaneous UL multi-panel transmission. It means that multiple panels (e.g. two panels) can be used for UL transmission at a time instant for a carrier. For multi-DCI based UL transmission, across different panels (e.g. two panels) in a same CC, PUSCH+PUSCH or PUCCH+PUCCH can be transmitted. It means that, if PUSCH transmission is transmitted by one panel of the two panels at a first given time instant, it is only allowed that another PUSCH transmission can be transmitted by the other panel of the two panels at the first give time instant of a carrier. Similarly, if PUCCH transmission is transmitted by one panel of the two panels at a second given time instant in a carrier, it is only allowed that another PUCCH transmission can be transmitted by the other panel of the two panels at the second give time instant.

This disclosure targets the issue of power control for simultaneous UL multi-panel transmission.

### BRIEF SUMMARY

Methods and apparatuses for power control for simultaneous PUSCH transmission in a cell are disclosed.

In one embodiment, a UE comprises a transceiver; and a processor coupled to the transceiver, wherein the processor is configured to transmit, via the transceiver, a configuration to configure one or multiple maximum output power values for a serving cell (c) and at least one of a first DCI associated with a first coresetPoolIndex value and a second DCI associated with a second coresetPoolIndex value different from the first coresetPoolIndex value, in a BWP (b) of a carrier (f) of the serving cell (c), the first DCI schedules a first PUSCH transmission associated with the first coresetPoolIndex value and the second DCI schedules a second PUSCH transmission associated with the second coresetPoolIndex value, the first PUSCH transmission and the second PUSCH transmission are in one slot; and receive, via the transceiver, at least one of the first PUSCH transmission and the second PUSCH transmission.

In a first implementation, if the configuration configures one maximum output power value P_{CMAX,f,c}, and one of the first PUSCH transmission and the second PUSCH transmission is scheduled in the one slot or the first PUSCH transmission and the second PUSCH transmission are scheduled to be non-overlapped in the one slot, then, the transmit power for each of the scheduled PUSCH transmission(s) is determined according to the one maximum output power value P_{CMAX,f,c}, power control parameters associated with an indicated TCI state used for the scheduled PUSCH transmission and the DCI scheduling the PUSCH transmission.

In a second implementation, if the configuration configures one maximum output power value P_{CMAX,f,c}, and the first PUSCH transmission and the second PUSCH transmission are scheduled to be overlapped in the one slot, then, a first candidate transmit power P_{PUSCH,b,f,c,0} for the first PUSCH transmission is determined according to the one maximum output power value P_{CMAX,f,c} and power control parameters associated with a first indicated TCI state applied for the first PUSCH transmission, and a second candidate transmit power P_{PUSCH,b,f,c,1} for the second PUSCH transmission is determined according to the one maximum output power value P_{CMAX,f,c} and power control parameters associated with a second indicated TCI state applied for the second PUSCH transmission, and if P_{PUSCH,b,f,c,0}+P_{PUSCH,b,f,c,1}≤ P_{CMAX,f,c}, the transmit power for the first PUSCH transmission is the first candidate transmit power P_{PUSCH,b,f,c,0}, and the transmit power for the second PUSCH transmission is the second candidate transmit power P_{PUSCH,b,f,c,1}, if P_{PUSCH,b,f,c,0}+P_{PUSCH,b,f,c,1}>P_{CMAX,f,c}, the transmit power for the first PUSCH transmission and the transmit power for the second PUSCH transmission are determined according to one of the following manners 1 to 3: manner 1: the transmit power for the first PUSCH transmission is

$$\frac{{P}_{PUSCH , b , f , c , 0}}{{P}_{PUSCH , b , f , c , 0} + {P}_{PUSCH , b , f , c , 1}} \times {P}_{CMAX , f , c} ,$$

and the transmit power for the second PUSCH transmission is

$$\frac{{P}_{PUSCH , b , f , c , 1}}{{P}_{PUSCH , b , f , c , 0} + {P}_{PUSCH , b , f , c , 1}} \times {P}_{C M A X , f , c} ,$$

manner 2: if the first PUSCH transmission has a higher priority than the second PUSCH transmission, the transmit power for the first PUSCH transmission is P_{PUSCH,b,f,c,0} and the transmit power for the second PUSCH transmission is P_{CMAX,f,c}-P_{PUSCH,b,f,c,0}; and if the second PUSCH transmission has a higher priority than the first PUSCH transmission, the transmit power for the second PUSCH transmission is P_{PUSCH,b,f,c,1} and the transmit power for the first PUSCH transmission is P_{CMAX,f,c}-P_{PUSCH,b,f,c,1}, and manner 3: the transmit power for the first PUSCH transmission is bate*P_{CMAX,f,c} and the transmit power for the second PUSCH transmission is (1−bate)*P_{CMAX,f,c}, where, bate is a configured power allocation factor with the range of 0≤bate≤1. In particular, the method may further comprise transmitting the first PUSCH transmission with the transmit power for the first PUSCH transmission if the transmit power for the first PUSCH transmission is higher than a dropping threshold; and transmitting the second PUSCH transmission with the transmit power for the second PUSCH transmission if the transmit power for the second PUSCH transmission is higher than the dropping threshold. In addition, the priority of the first PUSCH transmission and the second PUSCH transmission is determined according to at least one of coresetPoolIndex value associated with each of the first PUSCH transmission and the second PUSCH transmission, a TB size of each of the first PUSCH transmission and the second PUSCH transmission, a start symbol index of each of the first PUSCH transmission and the second PUSCH transmission, an end symbol index of each of the first PUSCH transmission and the second PUSCH transmission, and a duration of each of the first PUSCH transmission and the second PUSCH transmission.

In a third implementation, if the configuration configures a first maximum output power value P_{CMAX,f,c,0} associated with the first PUSCH transmission and a second maximum output power value P_{CMAX,f,c,1} associated with the second PUSCH transmission, and the first PUSCH transmission and the second PUSCH transmission are scheduled to be overlapped in the one slot, then, the transmit power for the first PUSCH transmission is determined according to the first maximum output power value P_{CMAX,f,c,0} associated with the first PUSCH transmission, power control parameters associated with a first indicated TCI state associated with the first coresetPoolIndex value used for the first PUSCH transmission, and the first DCI, and the transmit power for the second PUSCH transmission is determined according to the second maximum output power value P_{CMAX,f,c,1} associated with the second PUSCH transmission, power control parameters associated with a second indicated TCI state associated with the second coresetPoolIndex value used for the second PUSCH transmission, and the second DCI.

In a fourth implementation, if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1}, and the first PUSCH transmission and the second PUSCH transmission are scheduled to be non-overlapped in the one slot, then, the transmit power for the first PUSCH transmission is determined according to the first maximum output power value P_{CMAX,f,c,0} associated with the first PUSCH transmission, power control parameters associated with a first indicated TCI state associated with the first coresetPoolIndex value used for the first PUSCH transmission, and the first DCI, and the transmit power for the second PUSCH transmission is determined according to the second maximum output power value P_{CMAX,f,c,1} associated with the second PUSCH transmission, power control parameters associated with a second indicated TCI state associated with the second coresetPoolIndex value used for the second PUSCH transmission, and the second DCI.

In a fifth implementation, if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1}, and the first PUSCH transmission and the second PUSCH transmission are scheduled to be overlapped in the one slot, then, a first candidate transmit power P_{PUSCH,b,f,c,0} for the first PUSCH transmission is determined according to the first maximum output power value P_{CMAX,f,c,0} associated with the first PUSCH transmission, power control parameters associated with a first indicated TCI state associated with the first coresetPoolIndex value used for the first PUSCH transmission, and the first DCI, and a second candidate transmit power P_{PUSCH,b,f,c,1} for the second PUSCH transmission is determined according to the second maximum output power value P_{CMAX,f,c,1} associated with the second PUSCH transmission, power control parameters associated with a second indicated TCI state associated with the second coresetPoolIndex value used for the second PUSCH transmission, and the second DCI, if P_{PUSCH,b,f,c,0}+P_{PUSCH,b,f,c,1}≤P_{CMAX,f,c}, the transmit power for the first PUSCH transmission is the first candidate transmit power P_{PUSCH,b,f,c,0}, and the transmit power for the second PUSCH transmission is the second candidate transmit power P_{PUSCH,b,f,c,1}, if P_{PUSCH,b,f,c,0}+P_{PUSCH,b,f,c,1}>P_{CMAX,f,c}, the transmit power for the first PUSCH transmission and the transmit power for the second PUSCH transmission are determined according to one of the following manners 1 to 4, manner 1: the transmit power for the first PUSCH transmission is

$$min \{ {P}_{CMAX , f , c , 0} , \frac{{P}_{PUSCH , b , f , c , 0}}{{P}_{PUSCH , b , f , c , 0} + {P}_{PUSCH , b , f , c , 1}} \times {P}_{CMAX , f , c} \} ,$$

and the transmit power for the second PUSCH transmission is

$$min \{ {P}_{CMAX , f , c , 1} , \frac{{P}_{PUSCH , b , f , c , 1}}{{P}_{PUSCH , b , f , c , 0} + {P}_{PUSCH , b , f , c , 1}} \times {P}_{CMAX , f , c} \} ,$$

manner 2: the transmit power for the first PUSCH transmission is

$$min \{ {P}_{CMAX , f , c , 0} , \frac{{P}_{PUSCH , f , c , 0}}{{P}_{PUSCH , f , c , 0} + {P}_{PUSCH , f , c , 1}} \times {P}_{CMAX , f , c} \} ,$$

and the transmit power for the second PUSCH transmission is

$$min \{ {P}_{C M A X , f , c , 1} , \frac{{P}_{PUSCH , f , c , 1}}{{P}_{PUSCH , f , c , 0} + {P}_{PUSCH , f , c , 1}} \times {P}_{C M A X , f , c} \} ,$$

manner 3: if the first PUSCH transmission has a higher priority than the second PUSCH transmission, the transmit power for the first PUSCH transmission is P_{PUSCH,b,f,c,0} and the transmit power for the second PUSCH transmission is P_{CMAX,f,c}-P_{PUSCH,b,f,c,0}, and if the second PUSCH transmission has a higher priority than the first PUSCH transmission, the transmit power for the second PUSCH transmission is P_{PUSCH,b,f,c,1} and the transmit power for the first PUSCH transmission is P_{CMAX,f,c}-P_{PUSCH,b,f,c,1}, and manner 4: the transmit power for the first PUSCH transmission is bate*P_{CMAX,f,c} and the transmit power for the second PUSCH transmission is (1−bate)*P_{CMAX,f,c}, where, bate is a configured power allocation factor with the range of 0<bate≤1. In particular, the method may further comprise transmitting the first PUSCH transmission with the transmit power for the first PUSCH transmission if the transmit power for the first PUSCH transmission is higher than a dropping threshold; and transmitting the second PUSCH transmission with the transmit power for the second PUSCH transmission if the transmit power for the second PUSCH transmission is higher than the dropping threshold. In addition, the priority of the first PUSCH transmission and the second PUSCH transmission is determined according to at least one of coresetPoolIndex value associated with each of the first PUSCH transmission and the second PUSCH transmission, a TB size of each of the first PUSCH transmission and the second PUSCH transmission, a start symbol index of each of the first PUSCH transmission and the second PUSCH transmission, an end symbol index of each of the first PUSCH transmission and the second PUSCH transmission, and a duration of each of the first PUSCH transmission and the second PUSCH transmission.

In some embodiment, the processor is further configured to report, via the transceiver, a power headroom report (PHR) including two or three power headrooms (PHs) according to the configured one or multiple maximum output power values.

In a sixth implementation, if the configuration configures one maximum output power value P_{CMAX,f,c}, and a first PH and a second PH are included in the PHR, when one of the first PUSCH transmission and the second PUSCH transmission is scheduled in the one slot, the first PH is calculated based on the scheduled PUSCH transmission, and the second PH is calculated based on a reference PUSCH transmission with the power control parameters associated with a coresetPoolIndex value different from the coresetPoolIndex value associated with the scheduled PUSCH transmission, and when the first PUSCH transmission and the second PUSCH transmission are scheduled to be non-overlapped in the one slot, the first PH is calculated based on the one maximum output power value P_{CMAX,f,c}, power control parameters associated with a first indicated TCI state associated with the first coresetPoolIndex value used for the first PUSCH transmission, and the first DCI, and the second PH is calculated based on the one maximum output power value P_{CMAX,f,c}, power control parameters associated with a second indicated TCI state associated with the second coresetPoolIndex value used for the second PUSCH transmission, and the second DCI.

In a seventh implementation, if the configuration configures one maximum output power value P_{CMAX,f,c}, and a first PH, a second PH and a third PH are included in the PHR, when the first PUSCH transmission and the second PUSCH transmission are scheduled to be overlapped in the one slot, the first PH is calculated based on the one maximum output power value P_{CMAX,f,c}, power control parameters associated with a first indicated TCI state associated with the first coresetPoolIndex value used for the first PUSCH transmission, and the first DCI, the second PH is calculated based on the one maximum output power value P_{CMAX,f,c}, power control parameters associated with a second indicated TCI state associated with the second coresetPoolIndex value used for the second PUSCH transmission, and the second DCI, the third PH is calculated based on the one maximum output power value P_{CMAX,f,c}, power control parameters associated with a first indicated TCI state associated with the first coresetPoolIndex value used for the first PUSCH transmission, the first DCI, power control parameters associated with a second indicated TCI state associated with the second coresetPoolIndex value used for the second PUSCH transmission, and the second DCI.

In an eighth implementation, if the configuration configures a first maximum output power value P_{CMAX,f,c,0} associated with the first PUSCH transmission and a second maximum output power value P_{CMAX,f,c,1} associated with the second PUSCH transmission, and a first PH and a second PH are included in the PHR, when one of the first PUSCH transmission and the second PUSCH transmission is scheduled in the one slot, the first PH is calculated based on one of the first and the second maximum output power values associated with the scheduled PUSCH transmission, power control parameters associated with an indicated TCI state associated with the coresetPoolIndex value associated with the scheduled PUSCH transmission, and the DCI scheduling the PUSCH transmission, and the second PH is calculated based on the other of the first and the second maximum output power values assuming an allowed maximum power reduction MPR=0 dB, an additional maximum power reduction A-MPR=0, P-MPR=0 dB, an allowed operating band edge transmission power relaxation ΔTc=0 dB, and default power control parameters associated with a coresetPoolIndex value different from the coresetPoolIndex value associated with the scheduled PUSCH transmission, and when the first PUSCH transmission and the second PUSCH transmission are scheduled to be non-overlapped in the one slot, the first PH is calculated based on the first maximum output power value P_{CMAX,f,c,0} associated with the first coresetPoolIndex value, power control parameters associated with a first indicated TCI state associated with the first coresetPoolIndex value used for the first PUSCH transmission, and the first DCI, and the second PH is calculated based on the second maximum output power value P_{CMAX,f,c,1} associated with the second coresetPoolIndex value, power control parameters associated with a second indicated TCI state associated with the second coresetPoolIndex value used for the second PUSCH transmission, and the second DCI.

In a ninth implementation, if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1}, and a first PH and a second PH are included in the PHR, when one of the first PUSCH transmission and the second PUSCH transmission is scheduled in the one slot, the first PH is calculated based on one of the first and the second maximum output power values associated with the scheduled PUSCH transmission, power control parameters associated with an indicated TCI state associated with the coresetPoolIndex value associated with the scheduled PUSCH transmission, and the DCI scheduling the PUSCH transmission, and the second PH is calculated based on the other of the first and the second maximum output power values assuming an allowed maximum power reduction MPR=0 dB, an additional maximum power reduction A−MPR=0, P−MPR=0 dB, an allowed operating band edge transmission power relaxation ΔTc=0 dB, and default power control parameters associated with a coresetPoolIndex value different from the coresetPoolIndex value associated with the scheduled PUSCH transmission, and when the first PUSCH transmission and the second PUSCH transmission are scheduled to be non-overlapped in the one slot, the first PH is calculated based on the first maximum output power value P_{CMAX,f,c,0} associated with the first coresetPoolIndex value, power control parameters associated with a first indicated TCI state associated with the first coresetPoolIndex value used for the first PUSCH transmission, and the first DCI, and the second PH is calculated based on the second maximum output power value P_{CMAX,f,c,1} associated with the second coresetPoolIndex value, power control parameters associated with a second indicated TCI state associated with the second coresetPoolIndex value used for the second PUSCH transmission, and the second DCI.

In a tenth implementation, if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1}, and a first PH, a second PH and a third PH are included in the PHR, when the first PUSCH transmission and the second PUSCH transmission are scheduled to be overlapped in the one slot, the first PH is calculated based on the first maximum output power value P_{CMAX,f,c,0} associated with the first coresetPoolIndex value, power control parameters associated with a first indicated TCI state associated with the first coresetPoolIndex value used for the first PUSCH transmission, and the first DCI, the second PH is calculated based on the second maximum output power value P_{CMAX,f,c,1} associated with the second coresetPoolIndex value, power control parameters associated with a second indicated TCI state associated with the second coresetPoolIndex value used for the second PUSCH transmission, and the second DCI, and the third PH is calculated based on the additional maximum output power value P_{CMAX,f,c}, power control parameters associated with a first indicated TCI state associated with the first coresetPoolIndex value used for the first PUSCH transmission, the first DCI, power control parameters associated with a second indicated TCI state associated with the second coresetPoolIndex value used for the second PUSCH transmission, and the second DCI.

In another embodiment, a method performed at a UE comprises receiving a configuration to configure one or multiple maximum output power values for a serving cell (c) and at least one of a first DCI associated with a first coresetPoolIndex value and a second DCI associated with a second coresetPoolIndex value different from the first coresetPoolIndex value, in a BWP (b) of a carrier (f) of the serving cell (c), the first DCI schedules a first PUSCH transmission associated with the first coresetPoolIndex value and the second DCI schedules a second PUSCH transmission associated with the second coresetPoolIndex value, the first PUSCH transmission and the second PUSCH transmission are in one slot; and determining transmit power for each of the scheduled PUSCH transmission(s) according to the configured one or multiple maximum output power values.

In still another embodiment, a base unit comprises a transceiver; and a processor coupled to the transceiver, wherein the processor is configured to transmit, via the transceiver, a configuration to configure one or multiple maximum output power values for a serving cell (c) and at least one of a first DCI associated with a first coresetPoolIndex value and a second DCI associated with a second coresetPoolIndex value different from the first coresetPoolIndex value, in a BWP (b) of a carrier (f) of the serving cell (c), the first DCI schedules a first PUSCH transmission associated with the first coresetPoolIndex value and the second DCI schedules a second PUSCH transmission associated with the second coresetPoolIndex value, the first PUSCH transmission and the second PUSCH transmission are in one slot; and receive, via the transceiver, at least one of the first PUSCH transmission and the second PUSCH transmission.

In yet another embodiment, a method performed at a base unit comprises transmitting a configuration to configure one or multiple maximum output power values for a serving cell (c) and at least one of a first DCI associated with a first coresetPoolIndex value and a second DCI associated with a second coresetPoolIndex value different from the first coresetPoolIndex value, in a BWP (b) of a carrier (f) of the serving cell (c), the first DCI schedules a first PUSCH transmission associated with the first coresetPoolIndex value and the second DCI schedules a second PUSCH transmission associated with the second coresetPoolIndex value, the first PUSCH transmission and the second PUSCH transmission are in one slot; and receiving at least one of the first PUSCH transmission and the second PUSCH transmission.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method;

FIG. 2 is a schematic flow chart diagram illustrating an embodiment of another method; and

FIG. 3 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

“Multi-TRP” means that a serving cell can have multiple (e.g. two) TRPs. “Multi-panel” means that a UE can have multiple (e.g. two) panels. In the condition that a UE with two panels (e.g. panel #1 and panel #2) transmits UL signal (e.g. PUSCH transmissions) on a serving cell to two TRPs (e.g. TRP #1 and TRP #2), the UE may use one panel (e.g. panel #1) to transmit UL signal to one TRP (e.g. TRP #1) of the serving cell and use the other panel (e.g. panel #2) to transmit UL signal to another TRP (e.g. TRP #2) of the serving cell. So, one panel is associated with one TRP. For example, panel #1 is associated with TRP #1, and panel #2 is associated with TRP #2. So, multi-panel multi-TRP scenario can be described as multi-panel/TRP.

Incidentally, in the following description, ‘PUSCH transmission’ may be abbreviated as ‘PUSCH’, and ‘PUCCH resource’ may be abbreviated as ‘PUCCH’.

For multi-DCI based multi-panel/TRP UL transmission, each TRP may independently send DCI scheduling PUSCH or PUCCH to the same TRP. A UE may receive, from different (e.g. two) TRPs, multiple (e.g. two) DCIs scheduling multiple fully-overlapped or partial-overlapped or non-overlapped PUSCH or PUCCH transmissions in one slot. A RRC parameter coresetPoolIndex with value 0 or 1 is configured for a CORESET for TRP differential. For example, all CORESETs configured for TRP #1 is configured with coresetPoolIndex with value 0, and all the CORESETs configured for TRP #2 is configured with coresetPoolIndex with value 1.

“Multi-panel/TRP simultaneous UL transmission” means the UE transmit UL signals from multiple panels (e.g. two panels) to multiple TRPs (e.g. two TRPs) simultaneously.

“Multi-DCI based multi-panel/TRP simultaneous UL transmission” means that the UL signals (e.g. PUSCH) transmitted from multiple (e.g. two) panels to multiple TRPs (e.g. two TRPs) simultaneously are scheduled by multiple (e.g. two) DCIs. For example, the UL signal (e.g. PUSCH) transmitted from panel #1 to TRP #1 is scheduled by one DCI associated with coresetPoolIndex with value 0 (e.g. from TRP #1), and the UL signal (e.g. PUSCH) transmitted from panel #2 to TRP #2 is scheduled by another DCI associated with coresetPoolIndex with value 1 (e.g. from TRP #2) on the same symbol(s).

Two UL or joint TCI states associated with different coresetPoolIndex values are activated or indicated for UL signal transmitted from two panels to two TRPs for one BWP of a cell if unified TCI framework is configured, and are referred to as two indicated UL TCI states. UL TCI state is indicated when separate DL/UL TCI framework is configured, where the Tx beam for UL transmit and the Rx beam for DL reception are separately indicated by UL TCI state and DL TCI state, respectively. Each UL TCI state indicates a DL RS or an SRS for the UE to determine the TX spatial filter for UL transmission. In addition, a PL-RS is associated with the UL TCI state for the UE to calculate the DL channel path loss, and a set of power control parameters including P0, alpha and closed loop index for PUSCH is associated with each UL TCI state. Joint TCI state is indicated when joint DL/UL TCI framework is configured, where both Tx beam for UL transmission and Rx beam for DL reception are determined by the indicated joint TCI state. Each joint TCI state indicates a DL RS for the UE to determine the TX spatial filter for UL transmission, and the RX spatial filter for DL reception. In addition, a PL-RS is associated with the UL TCI state for the UE to calculate the DL channel path loss, and a set of power control parameters including P0, alpha and closed loop index for PUSCH is associated with each UL TCI state. Each PUSCH may be associated with one of the two indicated UL TCI states. For example, a first PUSCH scheduled by a first DCI associated with coresetPoolIndex value 0 is transmitted from panel #1 to TRP #1 associated with coresetPoolIndex value 0 by using the first indicated UL TCI state associated with coresetPoolIndex value 0 (i.e. the first indicated UL TCI state is applied to the first PUSCH), and a second PUSCH scheduled by a second DCI associated with coresetPoolIndex value 1 is transmitted from panel #2 to TRP #2 by using the second indicated UL TCI state associated with coresetPoolIndex value 1 (i.e. the second indicated UL TCI state is applied to the second PUSCH).

From UE hardware perspective, if the UE supports multi-panel simultaneous UL transmission, two independent RF chains or transmit branches each including independent PAs and PLLs should be equipped for the UE. Therefore, two maximum output power values for a carrier f of a serving cell c, e.g. P_{CMAX,f,c,0} and P_{CMAX,f,c,1}, can be configured by the UE, where each of two maximum output power values corresponds to a configured maximum output power value associated with one panel. For example, P_{CMAX,f,c,0} corresponds to a configured maximum output power value associated with panel #1 (or associated with coresetPoolIndex value 0), and P_{CMAX,f,c,1} corresponds to a configured maximum output power value associated with panel #2 (or associated with coresetPoolIndex value 1). If power sharing is supported between different panels (e.g. between panel #1 and panel #2), an additional maximum output power value, e.g. P_{CMAX,f,c} (where P_{CMAX,f,c}<P_{CMAX,f,c,0}+P_{CMAX,f,c,1}), may be configured for a carrier to restrict the total output power of two panels in the carrier.

Three cases can be considered for configuring the maximum output power value.

Case 1: one maximum output power value P_{CMAX,f,c} is configured for a UE for carrier f of a serving cell c.

Case 2: two maximum output power values, e.g. P_{CMAX,f,c,0} and P_{CMAX,f,c,1} are configured for a UE for carrier f of a serving cell c, where each one of P_{CMAX,f,c,0} and P_{CMAX,f,c,1} is associated with a transmitter branch of a carrier and further associated with a UL panel, an indicated UL TCI state and a coresetPoolIndex value. For example, P_{CMAX,f,c,0} is the maximum output power value associated with a first transmitter branch, panel #1, coresetPoolIndex value 0 and a first indicated UL TCI state (associated with coresetPoolIndex value 0); and P_{CMAX,f,c,1} is the maximum output power value associated with a second transmitter branch, panel #2, coresetPoolIndex value 1 and a second indicated UL TCI state (associated with coresetPoolIndex value 1).

Case 3: three maximum output power values, e.g., P_{CMAX,f,c}, P_{CMAX,f,c,0} and P_{CMAX,f,c,1} are configured for a UE for carrier f of a serving cell c, where P_{CMAX,f,c,0} and P_{CMAX,f,c,1} are the same as P_{CMAX,f,c,0} and P_{CMAX,f,c,1} described in Case 2, and P_{CMAX,f,c} (where P_{CMAX,f,c}<P_{CMAX,f,c,0}+P_{CMAX,f,c,1}, and P_{CMAX,f,c}>P_{CMAX,f,c,0}, and P_{CMAX,f,c}>P_{CMAX,f,C,1}) corresponds to the maximum output power value of the carrier.

For fully-overlapped or partially-overlapped (which can be collectively referred to as overlapped) scheduled two PUSCHs, a first PUSCH refers to the PUSCH scheduled by DCI carried by PDCCH from CORESET configured with coresetPoolIndex=0 or without configured CORESET (for this case, the UE will assume coresetPoolIndex=0 for this CORESET), and a second PUSCH refers to the PUSCH scheduled by DCI carried by PDCCH from CORESET configured with coresetPoolIndex=1. In particular, the first PUSCH is transmitted from panel #1 to TRP #1 by applying the first indicated TCI state associated with coresetPoolIndex=0, and the second PUSCH is transmitted from panel #2 to TRP #2 by applying the second indicated TCI state associated with coresetPoolIndex=1.

The first to the third embodiments relate to determining the transmit power for each of the scheduled PUSCH(s) in one slot, respectively, in Cases 1, 2 and 3.

A first embodiment relates to Case 1, i.e. one maximum output power value P_{CMAX,f,c} is configured for a UE for carrier f of a serving cell c.

If only one PUSCH or two non-overlapped PUSCHs are scheduled to be transmitted in one slot, the transmit power of each scheduled PUSCH transmission occasion i is determined by Equation 1.

$${P}_{PUSCH , b , f , c} ( i , j , {q}_{d} , l ) = min \{ \begin{matrix}{P}_{CMAX , f , c} ( i ) \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , c , f} ( {q}_{d} ) + {Δ}_{TF , b , f , c} ( i ) + {f}_{b , f , c} ( i , l )\end{matrix}\end{matrix} \} \qquad Equation 1$$

where, x=min{a, b} means that x equals to the minimal value between a and b. P_{CMAX,f,c}(i) is the configured maximum output power value P_{CMAX,f,c} for PUSCH transmission occasion i in the one slot. The parameters (i.e. P_{0_PUSCH,b,f,c}(j), M_{RRB,b,f,c}^{PUSCH}(l), α_{b,f,c}(j), PL_{b,f,c}(qa), Δ_{TF,b,f,c}(i), f_{b,f,c}(i, l)) to calculate P_{PUSCH,b,f,c}(i, j, q_{d}, l) are determined by the power control parameters associated with the indicated UL TCI state used for the PUSCH, and the scheduling DCI (i.e. the DCI scheduling the PUSCH). In detail, P_{0_PUSCH,b,f,c}(j) is the target receiving power at the gNB or TRP side of BWP b of carrier f of cell c. j corresponds to different PUSCH types, e.g., j=0 for PUSCH scheduled by DCI, j=1 for type 1 configured grant PUSCH, and j=2 for type 2 configured grant PUSCH. M_{RB,b,f,c}^{PUSCH}(i) is the number of PRBs scheduled for the PUSCH transmission, and 2″ corresponds to the sub-carrier space of the carrier of the cell. α_{b,f,c}(j) is the pathloss compensation factor with 0<αb,f,c(j)≤1. PL_{b,f,c}(qa) is the DL channel pathloss estimated based on a DL RS with index qa. Δ_{TF,b,f,c}(i) is the power adjustment according to the modulation of the scheduled PUSCH. f_{b,f,c}(i, l) is the closed loop power adjustment for the scheduled PUSCH transmission occasion i in closed loop I indicated by the scheduling DCI. For example, each indicated UL TCI state is associated with a P0 (i.e., P_{0_PUSCH,b,f,c}(j) in Equation 1), alpha (i.e., @b,f,c(j) in Equation 1) and l.

When two fully-overlapped or partially-overlapped PUSCHs (e.g. a first PUSCH associated with coresetPoolIndex=0, and a second PUSCH associated with coresetPoolIndex=1) are scheduled to be transmitted in one slot, the UE shall first determine the transmit power for each PUSCH by Equation 1. That is, a first candidate transmit power P_{PUSCH,b,f,c,0} (i, j, q_{d}, l) is determined for the first PUSCH (i.e. the PUSCH associated with coresetPoolIndex=0), where the parameters to calculate P_{PUSCH,b,f,c,0} (i, j, q_{d}, l) are determined according to the indicated UL TCI state applied to the first PUSCH. In addition, a second candidate transmit power P_{PUSCH,b,f,c,1} (i, j, q_{d}, l) is determined for the second PUSCH (i.e. the PUSCH associated with coresetPoolIndex=1), where the parameters to calculate P_{PUSCH,b,f,c,1} (i, j, q_{d}, l) are determined according to the indicated UL TCI state applied to the second PUSCH.

The UE further determines the actual transmit power for each of the first PUSCH and the second PUSCH according to the following procedure.

Step 11: if P_{PUSCH,b,f,c,0} (i, j, q_{d}, l)+P_{PUSCH,b,f,c,1} (i, j, q_{d}, l)≤P_{CMAX,f,c}(i), the UE transmits the first PUSCH with the first candidate transmit power of P_{PUSCH,b,f,c,0} (i, j, q_{d}, l), and transmits the second PUSCH with the second candidate transmit power of P_{PUSCH,b,f,c,1} (i, j, q_{d}, l).

Step 12: if P_{PUSCH,b,f,c,0} (i, j, q_{d}, l)+P_{PUSCH,b,f,c,1} (i, j, q_{d}, l)>P_{CMAX,f,c}(i), one the following solutions 11, 12 and 13 can be considered:
Solution 11: the UE directly allocates P_{CMAX,f,c}(i) to each of the first PUSCH and the second PUSCH proportionally according to the required transmit powers by the first PUSCH and the second PUSCH, for example,

$${P}_{PUSCH , b , f , c , 0}^{′} ( i , j , {q}_{d} , l ) = \frac{{P}_{P USCH , b , f , c , 0} ( i , j , {q}_{d} , l )}{{P}_{P U S C H , b , f , c , 0} ( i , j , {q}_{d} , l ) + {P}_{P U S C H , b , f , c , 1} ( i , j , {q}_{d} , l )} \times {P}_{CMAX , f , c} ( i )$$

$${P}_{PUSCH , b , f , c , 1}^{′} ( i , j , {q}_{d} , l ) = \frac{{P}_{P USCH , b , f , c , 1} ( i , j , {q}_{d} , l )}{{P}_{P U S C H , b , f , c , 0} ( i , j , {q}_{d} , l ) + {P}_{P U S C H , b , f , c , 1} ( i , j , {q}_{d} , l )} \times {P}_{CMAX , f , c} ( i )$$

where P′_{PUSCH,b,f,c,0}(i, j, q_{d}, l) is the actual transmit power for the first PUSCH, and P′_{PUSCH,b,f,c,1}(i, j, q_{d}, l) is the actual transmit power for the second PUSCH.

Solution 12: the UE allocates transmit power to the first PUSCH and the second PUSCH according to a priority. In detail, the UE first ensures the transmit power for the PUSCH with higher priority and then allocates the remaining power to the PUSCH with lower priority. For example, suppose the first PUSCH has a higher priority than the second PUSCH, then the UE allocates P_{PUSCH,b,f,c,0} (i, j, q_{d}, l) to the first PUSCH, and allocates (P_{CMAX,f,c}(i)-P_{PUSCH,b,f,c,0} (i, j, q_{d}, l)) to the second PUSCH. On the other hand, if the second PUSCH has a higher priority than the first PUSCH, then the UE allocates P_{PUSCH,b,f,c,1} (i, j, q_{d}, l) to the second PUSCH, and allocates (P_{CMAX,f,c}(i)−P_{PUSCH,b,f,c,1} (i, j, q_{d}, l)) to the first PUSCH. The priority can be determined by at least one of coresetPoolIndex value associated with each PUSCH, the TB size of each PUSCH, the start symbol index of each PUSCH, the end symbol index of each PUSCH, or the duration of each PUSCH. For example, any of criteria (11) to (15) can be used to determine which PUSCH has a higher priority:
(11) the PUSCH with larger TB size has higher priority than the PUSCH with smaller TB size;
(12) the PUSCH with smaller start symbol index has higher priority than the PUSCH with larger start symbol index;
(13) the PUSCH with smaller end symbol index has higher priority than the PUSCH with larger end symbol index;
(14) the PUSCH with larger duration has higher priority than the PUSCH with smaller duration; and
(15) the PUSCH associated with coresetPoolIndex=0 has higher priority than the PUSCH associated with coresetPoolIndex=1.

Incidentally, for each of criteria (11) to (14), if the compared values are the same, the priority of the PUSCHs is determined further by criterion (15).

Solution 13: the total power is allocated to the first PUSCH and the second PUSCH based on a RRC configured factor. For example, the gNB configures a power allocation factor, bate (with the range of 0<bate≤1), used for the total power allocation for two overlapped PUSCHs scheduled to be transmitted in one slot. When P_{PUSCH,b,f,c,0} (i, j, q_{d}, l)+P_{PUSCH,b,f,c,1} (i, j, q_{d}, l)>P_{CMAX,f,c}(i), bate*P_{CMAX,f,c}(i) is allocated to the first PUSCH (i.e. the PUSCH associated with coresetPoolIndex=0), and (1−bate)*P_{CMAX,f,c}(i) is allocated to the second PUSCH (i.e. the PUSCH associated with coresetPoolIndex=1).

Further, considering that transmitting a PUSCH with very low transmit power does not make sense, a dropping threshold can be configured or specified to determine whether the PUSCH with lower priority is transmitted. It means that, when the transmit power determined for a PUSCH (e.g. PUSCH with lower priority) is less than the dropping threshold, the PUSCH shall be dropped (i.e. not transmitted).

A second embodiment relates to Case 2, i.e. two maximum output power values, e.g. P_{CMAX,f,c,0} and P_{CMAX,f,c,1}, are configured for a UE for carrier f of a serving cell c. In particular, P_{CMAX,f,c,0} and P_{CMAX,f,c,1} are associated with a first panel (e.g. panel #1) and a second panel (e.g. panel #2) used for simultaneous UL transmission. In multi-DCI based multi-panel/TRP scenario, P_{CMAX,f,c,0} is the maximum output power value for the first PUSCH (i.e. the PUSCH associated with coresetPoolIndex=0) transmitted by the first panel (e.g. panel #0); and P_{CMAX,f,c,1} is the maximum output power value for the second PUSCH (i.e. the PUSCH associated with coresetPoolIndex=1) transmitted by the second panel (e.g. panel #1).

The UE shall determine the transmit power for each of the first PUSCH and the second PUSCH according to the coresetPoolIndex value associated therewith.

In particular, the UE determines the transmit power for the first PUSCH (i.e. PUSCH associated with coresetPoolIndex=0) based on Equation 2.

$${P}_{PUSCH , b , f , c , 0} ( i , j , {q}_{d} , l ) = min \{ \begin{matrix}{P}_{CMAX , f , c , 0} ( i ) \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , c , f} ( {q}_{d} ) + {Δ}_{TF , b , f , c} ( i ) + {f}_{b , f , c} ( i , l )\end{matrix} \} \qquad Equation 2$$

where, P_{CMAX,f,c,0} (i) is the configured maximum output power value P_{CMAX,f,c,0} for PUSCH transmission occasion i in the one slot associated with coresetPoolIndex=0. Other parameters (i.e. P_{0_PUSCH,b,f,c}(j), M_{RB,b,f,c}^{PUSCH}(i), α_{b,f,c}(j), PL_{b,f,c}(aa), Δ_{TF,b,f,c}(i), f_{b,f,c}(i, l) to calculate P_{PUSCH,b,f,c,0} (i, j, q_{d}, l)) are determined by the power control parameters associated with the indicated UL TCI state associated with coresetPoolIndex=0 used for the PUSCH, and the scheduling DCI.

The UE determines the transmit power for the second PUSCH (i.e. PUSCH associated with coresetPoolIndex=1) based on Equation 3.

$${P}_{PUSCH , b , f , c , 1} ( i , j , {q}_{d} , l ) = min \{ \begin{matrix}{P}_{CMAX , f , c , 1} ( i ) \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , c , f} ( {q}_{d} ) + {Δ}_{TF , b , f , c} ( i ) + {f}_{b , f , c} ( i , l )\end{matrix} \} \qquad Equation 3$$

where, P_{CMAX,f,c,1} (i) is the configured maximum output power value P_{CMAX,f,c,1} for PUSCH transmission occasion i in the one slot associated with coresetPoolIndex=1. Other parameters (i.e. P_{0_PUSCH,b,f,c}(j), M_{RB,b,f,c}^{PUSCH}(i), α_{b,f,c}(j), PL_{b,f,c}(q_{d}), Δ_{TF,b,f,c}(i), f_{b,f,c}(i,l) to calculate P_{PUSCH,b,f,c,1} (i, j, q_{d}, l)) are determined by the power control parameters associated with the indicated UL TCI state associated with coresetPoolIndex=1 used for the PUSCH, and the scheduling DCI.

A third embodiment relates to Case 3, i.e. three maximum output power values, e.g. P_{CMAX,f,c}, P_{CMAX,f,c,0} and P_{CMAX,f,c,1}, are configured for a UE for carrier f of a serving cell c.

P_{CMAX,f,c,0} and P_{CMAX,f,c,1} are the same as P_{CMAX,f,c,0} and P_{CMAX,f,c,1} described in the second embodiment. That is, P_{CMAX,f,c,0} and P_{CMAX,f,c,1} are associated with a first panel (e.g. panel #1) and a second panel (e.g. panel #2) used for simultaneous UL transmission. In multi-DCI based multi-panel/TRP scenario, P_{CMAX,f,c,0} is the maximum output power value for the first PUSCH (i.e. the PUSCH associated with coresetPoolIndex=0) transmitted by the first panel (e.g. panel #0); and P_{CMAX,f,c,1} is the maximum output power value for the second PUSCH (i.e. the PUSCH associated with coresetPoolIndex=1) transmitted by the second panel (e.g. panel #1).

P_{CMAX,f,c} is configured to restrict the total transmit power of the UE for carrier f of the serving cell c for simultaneous UL transmission. That is, P_{CMAX,f,c}<P_{CMAX,f,c,0}+P_{CMAX,f,c,1}, and P_{CMAX,f,c,0}>P_{CMAX,f,c,0}, P_{CMAX,f,c}>P_{CMAX,f,c,1} are configured.

For a first PUSCH and a second PUSCH that are non-overlapped in the one slot, the UE determines the transmit power for each PUSCH according to Equation 2 or Equation 3 based on the coresetPoolIndex value associated with the PUSCH.

For a first PUSCH and a second PUSCH that are fully-overlapped or partially-overlapped (e.g. a first PUSCH associated with coresetPoolIndex=0, and a second PUSCH associated with coresetPoolIndex=1), the UE shall determine the transmit power for each PUSCH according to the following procedure:

Step 31: calculate P_{PUSCH,b,f,c,0} (i, j, q_{d}, l) for the first PUSCH according to Equation 2 and calculate P_{PUSCH,b,f,c,1} (i, j, q_{d}, l) for the second PUSCH according to or Equation 3.

Step 32: compare PUSCH,_{b,f,c,0}(i, j, q_{d}, l)+PUSCH,_{b,f,c,1}(i, j, q_{d}, l) and P_{CMAX,f,c}.

Step 321: if P_{PUSCH,b,f,c,0} (i, j, q_{d}, l)+P_{PUSCH,b,f,c,1} (i, j, q_{d}, l)≤P_{CMAX,b,f,c}, the UE shall transmit the first PUSCH with the transmit power P_{PUSCH,b,f,c,0} (i, j, q_{d}, l) and transmit the second PUSCH with the transmit power P_{PUSCH,b,f,c,1} (i, j, q_{d}, l).

Step 322: if P_{PUSCH,b,f,c,0} (i, j, q_{d}, l)+P_{PUSCH,b,f,c,1}(i, j, q_{d}, l)>P_{CMAX,b,f,c}, then one of the following four solutions can be considered to determine the transmit power for each PUSCH.

Solution 31: the UE first allocates P_{CMAX,f,c}(i) to each PUSCH proportionally according to the required transmit powers, for example,

$${P}_{PUSCH , b , f , c , 0}^{′} ( i , j , {q}_{d} , l ) = \frac{{P}_{P USCH , b , f , c , 0} ( i , j , {q}_{d} , l )}{{P}_{P U S C H , b , f , c , 0} ( i , j , {q}_{d} , l ) + {P}_{P U S C H , b , f , c , 1} ( i , j , {q}_{d} , l )} \times {P}_{CMAX , f , c} ( i )$$

$${P}_{PUSCH , b , f , c , 1}^{′} ( i , j , {q}_{d} , l ) = \frac{{P}_{P USCH , b , f , c , 1} ( i , j , {q}_{d} , l )}{{P}_{P U S C H , b , f , c , 0} ( i , j , {q}_{d} , l ) + {P}_{P U S C H , b , f , c , 1} ( i , j , {q}_{d} , l )} \times {P}_{CMAX , f , c} ( i )$$

The actual transmit power for the first PUSCH is determined by

\tilde{P}_{PUSCH,b,f,c,0}(i,j,q_{d},l)=min{P_{CMAX,f,c,0}(i),P′_{PUSCH,b,f,c,0}(i,j,q_{d},l)}

The actual transmit power for the second PUSCH is determined by P_{PUSCH,b,f,c,1} (i, j, q_{d}, l)=min {P_{CMAX,f,c,1} (i), P′_{PUSCH,b,f,c,0}(i, j, q_{d}, l)}

Solution 32: the UE first allocates P_{CMAX,f,c}(i) to each PUSCH according to the configured maximum output power values for the first PUSCH and the second PUSCH, for example,

$${P}_{PUSCH , b , f , c , 0}^{′} ( i , j , {q}_{d} , l ) = \frac{{P}_{CMAX , f , c , 0}}{{P}_{CMAX , f , c , 0} + {P}_{CMAX , f , c , 1}} \times {P}_{CMAX , f , c} ( i )$$

$${P}_{PUSCH , b , f , c , 1}^{′} ( i , j , {q}_{d} , l ) = \frac{{P}_{CMAX , f , c , 1}}{{P}_{CMAX , f , c , 0} + {P}_{CMAX , f , c , 1}} \times {P}_{CMAX , f , c} ( i )$$

The actual transmit power for the first PUSCH is determined by

\tilde{P}_{PUSCH,b,f,c,0}(i,j,q_{d},l)=min{P_{CMAX,f,c,0}(i),P′_{PUSCH,b,f,c,0}(i,j,q_{d},l)}

The actual transmit power for the second PUSCH is determined by

\tilde{P}_{PUSCH,b,f,c,1}(i,j,q_{d},l)=min{P_{CMAX,f,c,1}(i),P′_{PUSCH,b,f,c,0}(i,j,q_{d},l)}

Solution 33: the UE allocates transmit power for the first PUSCH and transmit power for the second PUSCH according to a priority. In detail, the UE first ensures the transmit power for the PUSCH with higher priority and then allocates the remaining power to the PUSCH with lower priority. For example, suppose the first PUSCH has a higher priority than the second PUSCH, then the UE allocates P_{PUSCH,b,f,c,0} (i, j, q_{d}, l) to the first PUSCH, and allocates (P_{CMAX,f,c}(i)-P_{PUSCH,b,f,c,0} (i, j, q_{d}, l)) to the second PUSCH. On the other hand, if the second PUSCH has a higher priority than the first PUSCH, then the UE allocates P_{PUSCH,b,f,c,1} (i, j, q_{d}, l) to the second PUSCH, and allocates (P_{CMAX,f,c}(i)-P_{PUSCH,b,f,c,1} (i, j, q_{d}, l)) to the first PUSCH.

The priority can be determined by at least one of coresetPoolIndex value associated with each PUSCH, the TB size of each PUSCH, the start symbol index of each PUSCH, the end symbol index of each PUSCH, and the duration of each PUSCH. For example, any of criteria (31) to (35) can be used to determine which PUSCH has a higher priority:
(31) the PUSCH with larger TB size has higher priority than the PUSCH with smaller TB size;
(32) the PUSCH with smaller start symbol index has higher priority than the PUSCH with larger start symbol index;
(33) the PUSCH with smaller end symbol index has higher priority than the PUSCH with larger end symbol index;
(34) the PUSCH with larger duration has higher priority than the PUSCH with smaller duration; and
(35) the PUSCH associated with coresetPoolIndex=0 has higher priority than the PUSCH associated with coresetPoolIndex=1.

Incidentally, for each of criteria (31) to (34), if the compared values are the same, the priority of the PUSCHs is determined further by criterion (35).

Solution 34: the total power is allocated to the first PUSCH and the second PUSCH based on a RRC configured factor. For example, the gNB configures a power allocation factor, bate (with the range of 0≤bate≤1), used for the total power allocation for two overlapped PUSCHs scheduled to be transmitted in one slot. When P_{PUSCH,b,f,c,0} (i, j, q_{d}, l)+P_{PUSCH,b,f,c,1} (i, j, q_{d}, l)>P_{CMAX,f,c}(i), bate*P_{CMAX,f,c}(i) is allocated to the first PUSCH (i.e. the PUSCH associated with coresetPoolIndex=0), and (1−bate)*P_{CMAX,f,c}(i) is allocated to the second PUSCH (i.e. the PUSCH associated with coresetPoolIndex=1).

Further, considering that transmitting a PUSCH with very low transmit power does not make sense, a dropping threshold can be configured or specified to determine whether the PUSCH with lower priority is transmitted. It means that, when the transmit power determined for a PUSCH (e.g. PUSCH with lower priority) is less than the dropping threshold, the PUSCH shall be dropped (i.e. not transmitted).

The fourth embodiment to the sixth embodiment relate to calculating power headroom (PH).

Power headroom (PH) indicates the power availability for UL transmission. Type 1 PH reflects the PH assuming that PUSCH only transmits on a carrier and the PH is a measurement of the difference between the maximum output power value and the transmit power value that would have been used assuming that there would have been no upper limit on the transmit power. The PH can be transmitted from the UE to the gNB when the UE is scheduled to transmit on the UL-SCH. For example, when PUSCH(s) are scheduled to be transmitted from the UE, a PHR (power headroom report) including one or multiple PHs can be transmitted to the gNB. For example, for the UE supporting simultaneous UL transmission in multi-DCI multi-TRP mode, the gNB can configure the UE to report multiple PHs in a PHR in a cell according to UE capability report on whether multiple PHs (e.g., two PHs) can be configured in a cell.

So, multiple PHs are necessary to be calculated.

A fourth embodiment relates to calculating PHs in Case 1, i.e. one maximum output power value P_{CMAX,f,c} is configured for a UE for carrier f of a serving cell c.

According to the fourth embodiment, two or three PHs can be configured to be reported in a PHR for a cell.

When only one PUSCH is scheduled in one slot, if the UE is configured to report more than one PH (e.g. two PHs) in a cell, a first PH is an actual PH based on the PUSCH transmission, and a second PH is a virtual PH based on a reference PUSCH transmission with the power control parameters associated with a coresetPoolIndex value different from the coresetPoolIndex value associated with the actual PUSCH transmission.

When two non-overlapped PUSCHs are scheduled in one slot, two actual PHs, e.g. a first actual PH (i.e. PH_{type1,b,f,c,0}(i, j, q_{d}, l)) calculated according to the power control parameters associated with the first coresetPoolIndex (e.g. coresetPoolIndex=0) and a second actual PH (i.e. PH_{type1,b,f,c,1}(i, j, q_{d}, l)) calculated according to the power control parameters associated with the second coresetPoolIndex (e.g. coresetPoolIndex=1), are calculated.

For example, the first actual PH (i.e. PH_{type1,b,f,c,0}(i, j, q_{d}, l)) is calculated according to Equation 4.

$$P {H}_{type 1 , b , f , c , 0} ( i , j , {q}_{d} , l ) = {P}_{C M AX , f , c} ( i ) - \{ {P}_{{O}_{PUSCH} , b , f , c , 0} ( j ) + 10 {log}_{10} ( {2}^{μ} \cdot {M}_{R B , b , f , c}^{P U S CH , 0} ( i ) ) + {α}_{b , f , c , 0} ( j ) \cdot {PL}_{b , f , c , 0} ( {q}_{d} ) + {Δ}_{T F , b , f , c , 0} ( i ) + {f}_{b , f , c , 0} ( i , l ) \} \qquad Equation 4$$

where, P_{CMAX,f,c}(i) is the configured maximum output power value P_{CMAX,f,c} for PUSCH transmission occasion i in the one slot; the parameters P_{OPUSCH,b,f,c,0}(j), M_{RB,b,f,c}^{PUSCH,0}(i), α_{b,f,c,0}(j), P_{Lb,f,c,0}(qa), ΔT_{F,b,f,c,0}(i), f_{b,f,c,0}(i, l) are determined by the power control parameters associated with the indicated UL TCI state associated with coresetPoolIndex=0 used for the PUSCH, and the scheduling DCI.

The second actual PH (i.e. PH_{type1,b,f,c,1}(i, j, q_{d}, l)) is calculated according to Equation 5.

$$P {H}_{type 1 , b , f , c , 1} ( i , j , {q}_{d} , l ) = {P}_{C M AX , f , c} ( i ) - \{ {P}_{O \_ PUSCH , b , f , c , 1} ( j ) + 10 {log}_{10} ( {2}^{μ} \cdot {M}_{R B , b , f , c}^{P U S CH , 1} ( i ) ) + {α}_{b , f , c , 1} ( j ) \cdot {PL}_{b , f , c , 1} ( {q}_{d} ) + {Δ}_{T F , b , f , c , 1} ( i ) + {f}_{b , f , c , 1} ( i , l ) \} \qquad Equation 5$$

where, P_{CMAX,f,c}(i) is the configured maximum output power value P_{CMAX,f,c} for PUSCH transmission occasion i in the one slot; the parameters PO_{PUSCH,b,f,c,1}(j), M_{RB,b,f,c}^{PUSCH,1}((i), α_{b,f,c,1}(j), PL_{b,f,c,1}(q_{d}), Δ_{TF,b,f,c,1}(i), f_{b,f,c,1}(i, l) are determined by the power control parameters associated with the indicated UL TCI state associated with coresetPoolIndex=1 used for the PUSCH, and the scheduling DCI.

When two fully-overlapped or partially-overlapped PUSCHs are scheduled in one slot, in addition to the first actual PH (i.e. PH_{type1,b,f,c,0}(i, j, q_{d}, l)) and the second actual PH (i.e. PH_{type1,b,f,c,1}(i, j, q_{d}, l)), one additional PH (i.e. PH_{type1,b,f,c,2} (i, j, q_{d}, l)) can be calculated according to Equation 6.

$$P {H}_{type 1 , b , f , c , 2} ( i , j , {q}_{d} , l ) = {P}_{C M AX , f , c} ( i ) - \{ {P}_{O \_ PUSCH , b , f , c , 0} ( j ) + 10 {log}_{10} ( {2}^{μ} \cdot {M}_{RB , b , f , c}^{P U S CH , 0} ( i ) ) + {α}_{b , f , c , 0} ( j ) \cdot {PL}_{b , f , c , 0} ( {q}_{d} ) + {Δ}_{T F , b , f , c , 1} ( i ) + {f}_{b , f , c , 0} ( i , l ) \} - \{ {P}_{O \_ PUSCH , b , f , c , 1} ( j ) + 10 {log}_{10} ( {2}^{μ} \cdot {M}_{RB , b , f , c}^{P U S CH , 1} ( i ) ) + {α}_{b , f , c , 1} ( j ) \cdot {PL}_{b , f , c , 1} ( {q}_{d} ) + {Δ}_{T F , b , f , c , 1} ( i ) + {f}_{b , f , c , 1} ( i , l ) \} \qquad Equation 6$$

where, P_{CMAX,f,c}(i) is the configured maximum output power value P_{CMAX,f,c} for PUSCH transmission occasion i in the one slot; the parameters P_{OPUSCH,b,f,c,0}(j), M_{RB,b,f,c}^{PUSCH}(i), α_{b,f,c,0}(j), P_{Lb,f,c,0}(qa), ΔT_{F,b,f,c,0}(i), f_{b,f,c,0}(i, l) are determined by the power control parameters associated with the indicated UL TCI state associated with coresetPoolIndex=0 used for the PUSCH, and the scheduling DCI. The parameters P_{OPUSCH,b,f,c,1}(j), M_{RB,b,f,c}^{PUSCH,1}(i), α_{b,f,c,1}(j), PL_{b,f,c,1}(q_{d}), Δ_{TF,b,f,c,1}(i), f_{b,f,c,1}(i, l)) are determined by the power control parameters associated with the indicated UL TCI state associated with coresetPoolIndex=1 used for the PUSCH, and the scheduling DCI.

It means that three PHs can be calculated and reported in one PHR for a cell and PH_{type1,b,f,c,2} (i, j, q_{d}, l) reflects the power headroom assuming that the overlapped PUSCHs are transmitted with the expected powers.

A fifth embodiment relates to calculating PHs in Case 2, i.e. two maximum output power values, e.g. P_{CMAX,f,c,0} and P_{CMAX,f,c,1}, are configured for a UE for carrier f of a serving cell c.

According to the fifth embodiment, the gNB can configure the UE to report two PHs (e.g. a first PH and a second PH) in a PHR for a cell according to UE capability report.

When only one PUSCH is scheduled in one slot, and the UE the UE is triggered to report PHR, wherein the first PH is an actual PH calculated according to the actual PUSCH transmission based on Equation 7 (if the actual PUSCH transmission is associated with coresetPoolIndex=0) or Equation 8 (if the actual PUSCH transmission is associated with coresetPoolIndex=1).

$$P {H}_{type 1 , b , f , c , 0} ( i , j , {q}_{d} , l ) = {P}_{C M AX , f , c} ( i ) - \{ {P}_{O \_ PUSCH , b , f , c , 0} ( j ) + 10 {log}_{10} ( {2}^{μ} \cdot {M}_{R B , b , f , c}^{P U S CH , 0} ( i ) ) + {α}_{b , f , c , 0} ( j ) \cdot {PL}_{b , f , c , 0} ( {q}_{d} ) + {Δ}_{T F , b , f , c , 0} ( i ) + {f}_{b , f , c , 0} ( i , l ) \} \qquad Equation 7$$

where, P_{CMAX,f,c,0} (i) is the configured maximum output power value P_{CMAX,f,c,0} for PUSCH transmission occasion i in the one slot; the parameters P_{OPUSCH,b,f,c,0}(j), M_{RB,b,f,c}^{PUSCH}(i), α_{b,f,c,0}(j), P_{Lb,f,c,0}(qa), ΔT_{F,b,f,c,0}(i), f_{b,f,c,0}(i, l) are determined by the power control parameters associated with the UL TCI state associated with coresetPoolIndex=0 used for the PUSCH transmission, and the scheduling DCI.

$${PH}_{type 1 , b , f , c , 1} ( i , j , {q}_{d} , l ) = {P}_{CMAX , f , c , 1} ( i ) - \{ {P}_{O \_ PUSCH , b , f , c , 1} ( j ) + 10 {log}_{10} ( {2}^{μ} \cdot {M}_{RB , b , f , c}^{PUSCH , 1} ( i ) ) + {α}_{b , f , c , 1} ( j ) \cdot {PL}_{b , f , c , 1} ( {q}_{d} ) + {Δ}_{TF , b , f , c , 1} ( i ) + {f}_{b , f , c , 1} ( i , l ) \} \qquad Equation 8$$

where, P_{CMAX,f,c,1} (i) is the configured maximum output power value P_{CMAX,f,c,1} for PUSCH transmission occasion i in the one slot; the parameters P_{OPUSCH,b,f,c,1}(j), M_{RB,b,f,c}^{PUSCH,1}(i), α_{b,f,c,1}(j), PL_{b,f,c,1}(q_{d}), Δ_{TF,b,f,c,1}(i), f_{b,f,c,1}(i, l) are determined by the power control parameters associated with the UL TCI state associated with coresetPoolIndex=1 used for the PUSCH transmission, and the scheduling DCI.

The second PH is a virtual PH calculated according to a reference PUSCH transmission with the power control parameters associated with the indicated UL TCI state associated with a coresetPoolIndex value different from the coresetPoolIndex value associated with the actual PUSCH transmission based on Equation 9 (if the reference PUSCH transmission is associated with coresetPoolIndex=0) or Equation 10 (if the reference PUSCH transmission is associated with coresetPoolIndex=1).

$${PH}_{type 1 , b , f , c , 0} ( i , j , {q}_{d} , l ) = {\tilde{P}}_{CMAX , f , c , 0} ( i ) - \{ {P}_{O \_ PUSCH , b , f , c , 0} ( j ) + {α}_{b , f , c , 0} ( j ) \cdot {PL}_{b , f , c , 0} ( {q}_{d} ) + {f}_{b , f , c , 0} ( i , l ) \} \qquad Equation 9$$

where, \tilde{P}_{CMAX,f,c,0} (i) is computed from P_{CMAX,f,c,0} (i) assuming MPR (which is allowed maximum power reduction)=0 dB, A-MPR (which is additional maximum power reduction)=0, P-MPR=0 dB, ΔTc (which is allowed operating band edge transmission power relaxation)=0 dB defined in [8-1, TS 38.101-1], [8-2, TS38.101-2] and [8-3, TS 38.101-3]; and the parameters P0PUSCH,b,f,c,0(j), α_{b,f,c,0}(j), P_{Lb,f,c,0}(qa), f_{b,f,c,0}(i, l) are determined by default power control parameters associated with coresetPoolIndex=0.

$${PH}_{type 1 , b , f , c , 1} ( i , j , {q}_{d} , l ) = {\tilde{P}}_{CMAX , f , c , 1} ( i ) - \{ {P}_{O \_ PUSCH , b , f , c , 1} ( j ) + {α}_{b , f , c , 1} ( j ) \cdot {PL}_{b , f , c , 1} ( {q}_{d} ) + {f}_{b , f , c , 1} ( i , l ) \} \qquad Equation 10$$

where, \tilde{P}_{CMAX,f,c,1} (i) is computed from P_{CMAX,f,c,1} (i) assuming MPR=0 dB, A-MPR=0, P-MPR=0 dB, ΔTc=0 dB; and the parameters P_{OPUSCH,b,f,c,1}(j), α_{b,f,c,1}(j), PL_{b,f,c,1}(q_{d}), f_{b,f,c,1}(i, l) are determined by default power control parameters associated with coresetPoolIndex=1.

When two PUSCHs (e.g. two fully-overlapped or partially-overlapped or non-overlapped PUSCHs) (e.g. a first PUSCH associated with coresetPoolIndex=0, and a second PUSCH associated with coresetPoolIndex=1) are scheduled in one slot and the UE is triggered to report PHR in the one slot, two actual PHs (e.g. a first actual PH and a second actual PH) are calculated. In particular, the first actual PH is calculated based on the first PUSCH associated with coresetPoolIndex=0 according to Equation 7, and the second actual PH is calculated based on the second PUSCH associated with coresetPoolIndex=1 according to Equation 8.

A sixth embodiment relates to calculating PHs in Case 3, i.e. three maximum output power values, e.g. P_{CMAX,f,c}, P_{CMAX,f,c,0} and P_{CMAX,f,c,1}, are configured for a UE for carrier f of a serving cell c.

According to the sixth embodiment, two or three PHs can be configured to be reported in a PHR for a cell according to UE capability report.

When only one PUSCH is scheduled in one slot, and the UE is triggered to report PHR in the same slot, the first PH is an actual PH calculated according to the one PUSCH based on Equation 7 (if the one PUSCH is associated with coresetPoolIndex=0) or Equation 8 (if the one PUSCH is associated with coresetPoolIndex=1), and the second PH is a virtual PH calculated according to a reference PUSCH transmission with the power control parameters associated with the indicated UL TCI state associated with a coresetPoolIndex value different from the coresetPoolIndex value associated with the actual PUSCH transmission based on Equation 9 (if the reference PUSCH transmission is associated with coresetPoolIndex=0) or Equation 10 (if the reference PUSCH transmission is associated with coresetPoolIndex=1).

When two PUSCHs (e.g. two fully-overlapped or partially-overlapped or non-overlapped PUSCHs) (e.g. a first PUSCH associated with coresetPoolIndex=0, and a second PUSCH associated with coresetPoolIndex=1) are scheduled in one slot and the UE is triggered to report PHR in the one slot, two actual PHs (e.g. a first actual PH and a second actual PH) are calculated. In particular, the first actual PH is calculated based on the first PUSCH associated with coresetPoolIndex=0 according to Equation 7, and the second actual PH is calculated based on the second PUSCH associated with coresetPoolIndex=1 according to Equation 8.

When fully-overlapped or partially-overlapped PUSCHs are scheduled in one slot, an additional PH can be calculated according to Equation 6.

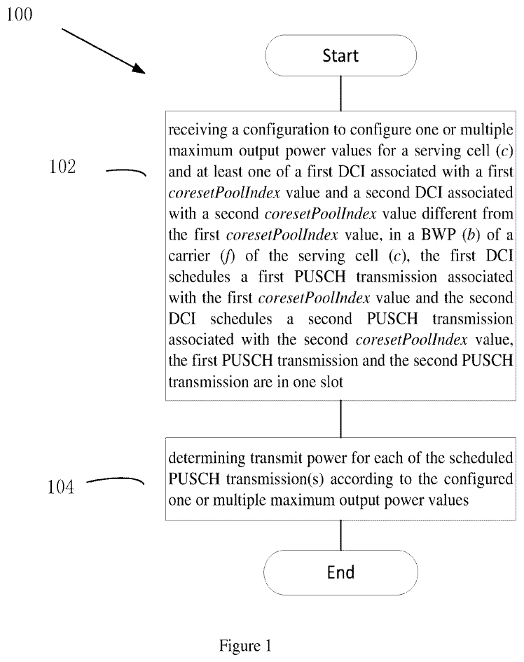

FIG. 1 is a schematic flow chart diagram illustrating an embodiment of a method 100 according to the present application. In some embodiments, the method 100 is performed by an apparatus, such as a remote unit (e.g. UE). In certain embodiments, the method 100 may be performed by a processor executing program code, for example, a microcontroller, a microprocessor, a CPU, a GPU, an auxiliary processing unit, a FPGA, or the like.

The method 100 is a method performed at a UE, comprising: 102 receiving a configuration to configure one or multiple maximum output power values for a serving cell (c) and at least one of a first DCI associated with a first coresetPoolIndex value and a second DCI associated with a second coresetPoolIndex value different from the first coresetPoolIndex value, in a BWP (b) of a carrier (f) of the serving cell (c), the first DCI schedules a first PUSCH transmission associated with the first coresetPoolIndex value and the second DCI schedules a second PUSCH transmission associated with the second coresetPoolIndex value, the first PUSCH transmission and the second PUSCH transmission are in one slot; and 104 determining transmit power for each of the scheduled PUSCH transmission(s) according to the configured one or multiple maximum output power values.

In a first implementation, if the configuration configures one maximum output power value P_{CMAX,f,c}, and one of the first PUSCH transmission and the second PUSCH transmission is scheduled in the one slot or the first PUSCH transmission and the second PUSCH transmission are scheduled to be non-overlapped in the one slot, then, the transmit power for each of the scheduled PUSCH transmission(s) is determined according to the one maximum output power value P_{CMAX,f,c}, power control parameters associated with an indicated TCI state used for the scheduled PUSCH transmission and the DCI scheduling the PUSCH transmission.

In a second implementation, if the configuration configures one maximum output power value P_{CMAX,f,c}, and the first PUSCH transmission and the second PUSCH transmission are scheduled to be overlapped in the one slot, then, a first candidate transmit power P_{PUSCH,b,f,c,0} for the first PUSCH transmission is determined according to the one maximum output power value P_{CMAX,f,c} and power control parameters associated with a first indicated TCI state applied for the first PUSCH transmission, and a second candidate transmit power P_{PUSCH,b,f,c,1} for the second PUSCH transmission is determined according to the one maximum output power value P_{CMAX,f,c} and power control parameters associated with a second indicated TCI state applied for the second PUSCH transmission, and if P_{PUSCH,b,f,c,0}+P_{PUSCH,b,f,c,1}≤P_{CMAX,f,c}, the transmit power for the first PUSCH transmission is the first candidate transmit power P_{PUSCH,b,f,c,0}, and the transmit power for the second PUSCH transmission is the second candidate transmit power P_{PUSCH,b,f,c,1}, if P_{PUSCH,b,f,c,0}+P_{PUSCH,b,f,c,1}>P_{CMAX,f,c}, the transmit power for the first PUSCH transmission and the transmit power for the second PUSCH transmission are determined according to one of the following manners 1 to 3: manner 1: the transmit power for the first PUSCH transmission is

$$\frac{{P}_{PUSCH , b , f , c , 0}}{{P}_{PUSCH , b , f , c , 0} + {P}_{PUSCH , b , f , c , 1}} \times {P}_{CMAX , f , c} ,$$

and the transmit power for the second PUSCH transmission is

$$\frac{{P}_{PUSCH , b , f , c , 1}}{{P}_{PUSCH , b , f , c , 0} + {P}_{PUSCH , b , f , c , 1}} \times {P}_{CMAX , f , c} ,$$

manner 2: if the first PUSCH transmission has a higher priority than the second PUSCH transmission, the transmit power for the first PUSCH transmission is P_{PUSCH,b,f,c,0} and the transmit power for the second PUSCH transmission is P_{CMAX,f,c}-P_{PUSCH,b,f,c,0}; and if the second PUSCH transmission has a higher priority than the first PUSCH transmission, the transmit power for the second PUSCH transmission is P_{PUSCH,b,f,c,1} and the transmit power for the first PUSCH transmission is P_{CMAX,f,c}-P_{PUSCH,b,f,c,1}, and manner 3: the transmit power for the first PUSCH transmission is bate*P_{CMAX,f,c} and the transmit power for the second PUSCH transmission is (1−bate)*P_{CMAX,f,c}, where, bate is a configured power allocation factor with the range of 0bate≤1. In particular, the method may further comprise transmitting the first PUSCH transmission with the transmit power for the first PUSCH transmission if the transmit power for the first PUSCH transmission is higher than a dropping threshold; and transmitting the second PUSCH transmission with the transmit power for the second PUSCH transmission if the transmit power for the second PUSCH transmission is higher than the dropping threshold. In addition, the priority of the first PUSCH transmission and the second PUSCH transmission is determined according to at least one of coresetPoolIndex value associated with each of the first PUSCH transmission and the second PUSCH transmission, a TB size of each of the first PUSCH transmission and the second PUSCH transmission, a start symbol index of each of the first PUSCH transmission and the second PUSCH transmission, an end symbol index of each of the first PUSCH transmission and the second PUSCH transmission, and a duration of each of the first PUSCH transmission and the second PUSCH transmission. In a third implementation, if the configuration configures a first maximum output power value P_{CMAX,f,c,0} associated with the first PUSCH transmission and a second maximum output power value P_{CMAX,f,c,1} associated with the second PUSCH transmission, and the first PUSCH transmission and the second PUSCH transmission are scheduled to be overlapped in the one slot, then, the transmit power for the first PUSCH transmission is determined according to the first maximum output power value P_{CMAX,f,c,0} associated with the first PUSCH transmission, power control parameters associated with a first indicated TCI state associated with the first coresetPoolIndex value used for the first PUSCH transmission, and the first DCI, and the transmit power for the second PUSCH transmission is determined according to the second maximum output power value P_{CMAX,f,c,1} associated with the second PUSCH transmission, power control parameters associated with a second indicated TCI state associated with the second coresetPoolIndex value used for the second PUSCH transmission, and the second DCI.

In a fourth implementation, if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1}, and the first PUSCH transmission and the second PUSCH transmission are scheduled to be non-overlapped in the one slot, then, the transmit power for the first PUSCH transmission is determined according to the first maximum output power value P_{CMAX,f,c,0} associated with the first PUSCH transmission, power control parameters associated with a first indicated TCI state associated with the first coresetPoolIndex value used for the first PUSCH transmission, and the first DCI, and the transmit power for the second PUSCH transmission is determined according to the second maximum output power value P_{CMAX,f,c,1} associated with the second PUSCH transmission, power control parameters associated with a second indicated TCI state associated with the second coresetPoolIndex value used for the second PUSCH transmission, and the second DCI.

In a fifth implementation, if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1}, and the first PUSCH transmission and the second PUSCH transmission are scheduled to be overlapped in the one slot, then, a first candidate transmit power P_{PUSCH,b,f,c,0} for the first PUSCH transmission is determined according to the first maximum output power value P_{CMAX,f,c,0} associated with the first PUSCH transmission, power control parameters associated with a first indicated TCI state associated with the first coresetPoolIndex value used for the first PUSCH transmission, and the first DCI, and a second candidate transmit power P_{PUSCH,b,f,c,1} for the second PUSCH transmission is determined according to the second maximum output power value P_{CMAX,f,c,1} associated with the second PUSCH transmission, power control parameters associated with a second indicated TCI state associated with the second coresetPoolIndex value used for the second PUSCH transmission, and the second DCI, if P_{PUSCH,b,f,c,0}+P_{PUSCH,b,f,c,1}≤P_{CMAX,f,c}, the transmit power for the first PUSCH transmission is the first candidate transmit power P_{PUSCH,b,f,c,0}, and the transmit power for the second PUSCH transmission is the second candidate transmit power P_{PUSCH,b,f,c,1}, if P_{PUSCH,b,f,c,0}+P_{PUSCH,b,f,c,1}>P_{CMAX,f,c}, the transmit power for the first PUSCH transmission and the transmit power for the second PUSCH transmission are determined according to one of the following manners 1 to 4, manner 1: the transmit power for the first PUSCH transmission is

$$min \{ {P}_{CMAX , f , c , 0} , \frac{{P}_{PUSCH , b , f , c , 0}}{{P}_{PUSCH , b , f , c , 0} + {P}_{PUSCH , b , f , c , 1}} \times {P}_{CMAX , f , c} \} ,$$

and the transmit power for the second PUSCH transmission is

$$min \{ {P}_{CMAX , f , c , 1} , \frac{{P}_{PUSCH , b , f , c , 1}}{{P}_{PUSCH , b , f , c , 0} + {P}_{PUSCH , b , f , c , 1}} \times {P}_{CMAX , f , c} \} ,$$

manner 2: the transmit power for the first PUSCH transmission is

$$min \{ {P}_{CMAX , f , c , 0} , \frac{{P}_{CMAX , f , c , 0}}{{P}_{CMAX , f , c , 0} + {P}_{CMAX , f , c , 1}} \times {P}_{CMAX , f , c} \} ,$$

and the transmit power for the second PUSCH transmission is

$$min \{ {P}_{CMAX , f , c , 1} , \frac{{P}_{CMAX , f , c , 1}}{{P}_{CMAX , f , c , 0} + {P}_{CMAX , f , c , 1}} \times {P}_{CMAX , f , c} \} ,$$

manner 3: if the first PUSCH transmission has a higher priority than the second PUSCH transmission, the transmit power for the first PUSCH transmission is P_{PUSCH,b,f,c,0} and the transmit power for the second PUSCH transmission is P_{CMAX,f,c}-P_{PUSCH,b,f,c,0}; and if the second PUSCH transmission has a higher priority than the first PUSCH transmission, the transmit power for the second PUSCH transmission is P_{PUSCH,b,f,c,1} and the transmit power for the first PUSCH transmission is P_{CMAX,f,c}-P_{PUSCH,b,f,c,1}, and manner 4: the transmit power for the first PUSCH transmission is bate*P_{CMAX,f,c} and the transmit power for the second PUSCH transmission is (1−bate)*P_{CMAX,f,c}, where, bate is a configured power allocation factor with the range of 0≤bate≤1. In particular, the method may further comprise transmitting the first PUSCH transmission with the transmit power for the first PUSCH transmission if the transmit power for the first PUSCH transmission is higher than a dropping threshold; and transmitting the second PUSCH transmission with the transmit power for the second PUSCH transmission if the transmit power for the second PUSCH transmission is higher than the dropping threshold. In addition, the priority of the first PUSCH transmission and the second PUSCH transmission is determined according to at least one of coresetPoolIndex value associated with each of the first PUSCH transmission and the second PUSCH transmission, a TB size of each of the first PUSCH transmission and the second PUSCH transmission, a start symbol index of each of the first PUSCH transmission and the second PUSCH transmission, an end symbol index of each of the first PUSCH transmission and the second PUSCH transmission, and a duration of each of the first PUSCH transmission and the second PUSCH transmission.

In one embodiment, the method 100 may further comprise 106 reporting a power headroom report (PHR) including two or three power headrooms (PHs) according to the configured one or multiple maximum output power values. The step 106 can be performed with or without the step 104. When the step 104 is not included, a method 100′ comprises step 102 and 106.

The calculation of PHs can be implemented in the following sixth to the tenth implementations, no matter whether the step 104 is included in the method 100 or the step 104 is not included in the method 100′.

In a sixth implementation, if the configuration configures one maximum output power value P_{CMAX,f,c}, and a first PH and a second PH are included in the PHR, when one of the first PUSCH transmission and the second PUSCH transmission is scheduled in the one slot, the first PH is calculated based on the scheduled PUSCH transmission, and the second PH is calculated based on a reference PUSCH transmission with the power control parameters associated with a coresetPoolIndex value different from the coresetPoolIndex value associated with the scheduled PUSCH transmission, and when the first PUSCH transmission and the second PUSCH transmission are scheduled to be non-overlapped in the one slot, the first PH is calculated based on the one maximum output power value P_{CMAX,f,c}, power control parameters associated with a first indicated TCI state associated with the first coresetPoolIndex value used for the first PUSCH transmission, and the first DCI, and the second PH is calculated based on the one maximum output power value P_{CMAX,f,c}, power control parameters associated with a second indicated TCI state associated with the second coresetPoolIndex value used for the second PUSCH transmission, and the second DCI.

In a seventh implementation, if the configuration configures one maximum output power value P_{CMAX,f,c}, and a first PH, a second PH and a third PH are included in the PHR, when the first PUSCH transmission and the second PUSCH transmission are scheduled to be overlapped in the one slot, the first PH is calculated based on the one maximum output power value P_{CMAX,f,c}, power control parameters associated with a first indicated TCI state associated with the first coresetPoolIndex value used for the first PUSCH transmission, and the first DCI, the second PH is calculated based on the one maximum output power value P_{CMAX,f,c}, power control parameters associated with a second indicated TCI state associated with the second coresetPoolIndex value used for the second PUSCH transmission, and the second DCI, the third PH is calculated based on the one maximum output power value P_{CMAX,f,c}, power control parameters associated with a first indicated TCI state associated with the first coresetPoolIndex value used for the first PUSCH transmission, the first DCI, power control parameters associated with a second indicated TCI state associated with the second coresetPoolIndex value used for the second PUSCH transmission, and the second DCI.

In an eighth implementation, if the configuration configures a first maximum output power value P_{CMAX,f,c,0} associated with the first PUSCH transmission and a second maximum output power value P_{CMAX,f,c,1} associated with the second PUSCH transmission, and a first PH and a second PH are included in the PHR, when one of the first PUSCH transmission and the second PUSCH transmission is scheduled in the one slot, the first PH is calculated based on one of the first and the second maximum output power values associated with the scheduled PUSCH transmission, power control parameters associated with an indicated TCI state associated with the coresetPoolIndex value associated with the scheduled PUSCH transmission, and the DCI scheduling the PUSCH transmission, and the second PH is calculated based on the other of the first and the second maximum output power values assuming an allowed maximum power reduction MPR=0 dB, an additional maximum power reduction A-MPR=0, P-MPR=0 dB, an allowed operating band edge transmission power relaxation ΔTc=0 dB, and default power control parameters associated with a coresetPoolIndex value different from the coresetPoolIndex value associated with the scheduled PUSCH transmission, and when the first PUSCH transmission and the second PUSCH transmission are scheduled to be non-overlapped in the one slot, the first PH is calculated based on the first maximum output power value P_{CMAX,f,c,0} associated with the first coresetPoolIndex value, power control parameters associated with a first indicated TCI state associated with the first coresetPoolIndex value used for the first PUSCH transmission, and the first DCI, and the second PH is calculated based on the second maximum output power value P_{CMAX,f,c,1} associated with the second coresetPoolIndex value, power control parameters associated with a second indicated TCI state associated with the second coresetPoolIndex value used for the second PUSCH transmission, and the second DCI.

In a ninth implementation, if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1,} and a first PH and a second PH are included in the PHR, when one of the first PUSCH transmission and the second PUSCH transmission is scheduled in the one slot, the first PH is calculated based on one of the first and the second maximum output power values associated with the scheduled PUSCH transmission, power control parameters associated with an indicated TCI state associated with the coresetPoolIndex value associated with the scheduled PUSCH transmission, and the DCI scheduling the PUSCH transmission, and the second PH is calculated based on the other of the first and the second maximum output power values assuming an allowed maximum power reduction MPR=0 dB, an additional maximum power reduction A-MPR=0, P-MPR=0 dB, an allowed operating band edge transmission power relaxation ΔTc=0 dB, and default power control parameters associated with a coresetPoolIndex value different from the coresetPoolIndex value associated with the scheduled PUSCH transmission, and when the first PUSCH transmission and the second PUSCH transmission are scheduled to be non-overlapped in the one slot, the first PH is calculated based on the first maximum output power value P_{CMAX,f,c,0} associated with the first coresetPoolIndex value, power control parameters associated with a first indicated TCI state associated with the first coresetPoolIndex value used for the first PUSCH transmission, and the first DCI, and the second PH is calculated based on the second maximum output power value P_{CMAX,f,c,1} associated with the second coresetPoolIndex value, power control parameters associated with a second indicated TCI state associated with the second coresetPoolIndex value used for the second PUSCH transmission, and the second DCI.

In a tenth implementation, if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1}, and a first PH, a second PH and a third PH are included in the PHR, when the first PUSCH transmission and the second PUSCH transmission are scheduled to be overlapped in the one slot, the first PH is calculated based on the first maximum output power value P_{CMAX,f,c,0} associated with the first coresetPoolIndex value, power control parameters associated with a first indicated TCI state associated with the first coresetPoolIndex value used for the first PUSCH transmission, and the first DCI, the second PH is calculated based on the second maximum output power value P_{CMAX,f,c,1} associated with the second coresetPoolIndex value, power control parameters associated with a second indicated TCI state associated with the second coresetPoolIndex value used for the second PUSCH transmission, and the second DCI, and the third PH is calculated based on the additional maximum output power value P_{CMAX,f,c}, power control parameters associated with a first indicated TCI state associated with the first coresetPoolIndex value used for the first PUSCH transmission, the first DCI, power control parameters associated with a second indicated TCI state associated with the second coresetPoolIndex value used for the second PUSCH transmission, and the second DCI.

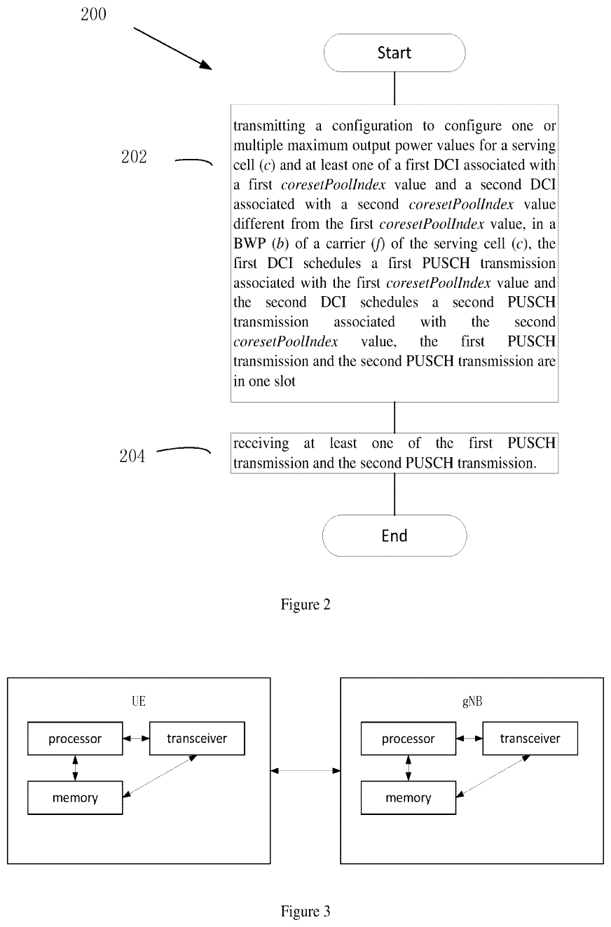

FIG. 2 is a schematic flow chart diagram illustrating an embodiment of a method 200 according to the present application. In some embodiments, the method 200 is performed by an apparatus, such as a base unit. In certain embodiments, the method 200 may be performed by a processor executing program code, for example, a microcontroller, a microprocessor, a CPU, a GPU, an auxiliary processing unit, a FPGA, or the like.

The method 200 may comprise 202 transmitting a configuration to configure one or multiple maximum output power values for a serving cell (c) and at least one of a first DCI associated with a first coresetPoolIndex value and a second DCI associated with a second coresetPoolIndex value different from the first coresetPoolIndex value, in a BWP (b) of a carrier (f) of the serving cell (c), the first DCI schedules a first PUSCH transmission associated with the first coresetPoolIndex value and the second DCI schedules a second PUSCH transmission associated with the second coresetPoolIndex value, the first PUSCH transmission and the second PUSCH transmission are in one slot; and 204 receiving at least one of the first PUSCH transmission and the second PUSCH transmission.

The method may further comprise 206 receiving a power headroom report (PHR) including two or three power headrooms (PHs) determined according to the configured one or multiple maximum output power values. The step 206 can be performed with or without the step 204. When the step 204 is not included, a method 200′ comprises step 202 and 206.

FIG. 3 is a schematic block diagram illustrating apparatuses according to one embodiment.

Referring to FIG. 3, the UE (i.e. the remote unit) includes a processor, a memory, and a transceiver. The processor implements a function, a process, and/or a method which are proposed in FIG. 1.

The UE comprises a transceiver; and a processor coupled to the transceiver, wherein the processor is configured to receive, via the transceiver, a configuration to configure one or multiple maximum output power values for a serving cell (c) and at least one of a first DCI associated with a first coresetPoolIndex value and a second DCI associated with a second coresetPoolIndex value different from the first coresetPoolIndex value, in a BWP (b) of a carrier (f) of the serving cell (c), the first DCI schedules a first PUSCH transmission associated with the first coresetPoolIndex value and the second DCI schedules a second PUSCH transmission associated with the second coresetPoolIndex value, the first PUSCH transmission and the second PUSCH transmission are in one slot; and determine transmit power for each of the scheduled PUSCH transmission(s) according to the configured one or multiple maximum output power values.

The first to the fifth implementations described with reference to method 100 also apply to the UE.

In one embodiment, the processor is further configured to report, via the transceiver, a power headroom report (PHR) including two or three power headrooms (PHs) according to the configured one or multiple maximum output power values. Similar to the description to step 106 of method 100, the processor may be configured to report the PHR without determining transmit power for each of the scheduled PUSCH transmission(s).

The calculation of PHs can be implemented in the above described sixth to tenth implementations, no matter whether the processor is configured to determine the transmit power for each of the scheduled PUSCH transmission(s).

The gNB (i.e. the base unit) includes a processor, a memory, and a transceiver. The processor implements a function, a process, and/or a method which are proposed in FIG. 2.

The base unit comprises a transceiver; and a processor coupled to the transceiver, wherein the processor is configured to transmit, via the transceiver, a configuration to configure one or multiple maximum output power values for a serving cell (c) and at least one of a first DCI associated with a first coresetPoolIndex value and a second DCI associated with a second coresetPoolIndex value different from the first coresetPoolIndex value, in a BWP (b) of a carrier (f) of the serving cell (c), the first DCI schedules a first PUSCH transmission associated with the first coresetPoolIndex value and the second DCI schedules a second PUSCH transmission associated with the second coresetPoolIndex value, the first PUSCH transmission and the second PUSCH transmission are in one slot; and receive, via the transceiver, at least one of the first PUSCH transmission and the second PUSCH transmission.

In one embodiment, the processor may be further configured to receive a power headroom report (PHR) including two or three power headrooms (PHs) determined according to the configured one or multiple maximum output power values. Similar to the description to step 206, the processor may be configured to receive the PHR without receiving at least one of the first PUSCH transmission and the second PUSCH transmission.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

What is claimed is:

1-15. (canceled)

16. A user equipment (UE) for wireless communication, comprising:
at least one memory; and
at least one processor coupled with the at least one memory and configured to cause the UE to:
receive a configuration to configure multiple maximum output power values in a bandwidth part (BWP) of a carrier of a serving cell based at least in part on the UE being indicated with a first Uplink (UL) or joint Transmission Configuration Indicator (TCI) state and a second UL or joint TCI state; and
determine transmit power for UL transmission according to the configured maximum output power values corresponding to at least one of the first UL or joint TCI state or the second UL or joint TCI state associated with the UL transmission.

17. The UE of claim 16, wherein the at least one processor is configured to cause the UE to receive a first Downlink Control Information (DCI) associated with a first coresetPoolIndex value and a second DCI associated with a second coresetPoolIndex value different from the first coresetPoolIndex value, in the BWP of the carrier of the serving cell, the first DCI scheduling a first physical uplink shared channel (PUSCH) transmission associated with the first coresetPoolIndex value and the second DCI scheduling a second PUSCH transmission associated with the second coresetPoolIndex value, the first PUSCH transmission and the second PUSCH transmission being in one slot.

18. The UE of claim 17, wherein the UL transmission comprises one or more of the first PUSCH transmission or the second PUSCH transmission.

19. The UE of claim 16, wherein the UL transmission comprises one or more of a first PUSCH transmission or a second PUSCH transmission, and wherein if the configuration configures one maximum output power value P_{CMAX,f,c}, and the first PUSCH transmission and the second PUSCH transmission are scheduled to be overlapped in the one slot, then, a first transmit power P_{PUSCH,b,f,c,0} for the first PUSCH transmission is determined according to the one maximum output power value P_{CMAX,f,c} and power control parameters associated with a first indicated TCI state applied for the first PUSCH transmission, and a second transmit power P_{PUSCH,b,f,c,1} for the second PUSCH transmission is determined according to the one maximum output power value P_{CMAX,f,c} and power control parameters associated with a second indicated TCI state applied for the second PUSCH transmission;
if P_{PUSCH,b,f,c,0}+P_{PUSCH,b,f,c,1}≤P_{CMAX,f,c}, the transmit power for the first PUSCH transmission is the first candidate transmit power P_{PUSCH,b,f,c,0}, and the transmit power for the second PUSCH transmission is the second candidate transmit power P_{PUSCH,b,f,c,1}, and
if P_{PUSCH,b,f,c,0}+P_{PUSCH,b,f,c,1}>P_{CMAX,f,c}, the transmit power for the first PUSCH transmission and the transmit power for the second PUSCH transmission are determined according to at least one of:
the transmit power for the first PUSCH transmission is
$$\frac{{P}_{PUSCH , b , f , c , 0}}{{P}_{PUSCH , b , f , c , 0} + {P}_{PUSCH , b , f , c , 1}} \times {P}_{CMAX , f , c} ,$$
and the transmit power for the second PUSCH transmission is
$$\frac{{P}_{PUSCH , b , f , c , 1}}{{P}_{PUSCH , b , f , c , 0} + {P}_{PUSCH , b , f , c , 1}} \times {P}_{CMAX , f , c} ;$$
if the first PUSCH transmission has a higher priority than the second PUSCH transmission, the transmit power for the first PUSCH transmission is P_{PUSCH,b,f,c,0} and the transmit power for the second PUSCH transmission is P_{CMAX,f,c}-P_{PUSCH,b,f,c,0}; and if the second PUSCH transmission has a higher priority than the first PUSCH transmission, the transmit power for the second PUSCH transmission is P_{PUSCH,b,f,c,1} and the transmit power for the first PUSCH transmission is P_{CMAX,f,c}-P_{PUSCH,b,f,c,1}; or
the transmit power for the first PUSCH transmission is bate*P_{CMAX,f,c} and the transmit power for the second PUSCH transmission is (1−bate)*P_{CMAX,f,c}, where, bate is a configured power allocation factor with the range of 0≤bate≤1.

20. The UE of claim 19, wherein the at least one processor is configured to cause the UE to:
transmit the first PUSCH transmission with the transmit power for the first PUSCH transmission if the transmit power for the first PUSCH transmission is higher than a dropping threshold; and
transmit the second PUSCH transmission with the transmit power for the second PUSCH transmission if the transmit power for the second PUSCH transmission is higher than the dropping threshold.

21. The UE of claim 19, wherein the priority of the first PUSCH transmission and the second PUSCH transmission is determined according to at least one of:
coresetPoolIndex value associated with each of the first PUSCH transmission and the second PUSCH transmission;
a transport block (TB) size of each of the first PUSCH transmission and the second PUSCH transmission;
a start symbol index of each of the first PUSCH transmission and the second PUSCH transmission;
an end symbol index of each of the first PUSCH transmission and the second PUSCH transmission; or
a duration of each of the first PUSCH transmission and the second PUSCH transmission.

22. The UE of claim 16, wherein, if the configuration configures a first maximum output power value P_{CMAX,f,c,0} associated with the first PUSCH transmission and a second maximum output power value P_{CMAX,f,c,1} associated with the second PUSCH transmission, and the first PUSCH transmission and the second PUSCH transmission are scheduled to be overlapped in the one slot, then:
the transmit power for the first PUSCH transmission is determined according to the first maximum output power value P_{CMAX,f,c,0} associated with the first PUSCH transmission, power control parameters associated with a first indicated TCI state associated with the first coresetPoolIndex value used for the first PUSCH transmission, and the first DCI; and
the transmit power for the second PUSCH transmission is determined according to the second maximum output power value P_{CMAX,f,c,1} associated with the second PUSCH transmission, power control parameters associated with a second indicated TCI state associated with the second coresetPoolIndex value used for the second PUSCH transmission, and the second DCI.

23. The UE of claim 16, wherein, if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1,} and the first PUSCH transmission and the second PUSCH transmission are scheduled to be non-overlapped in the one slot, then:
the transmit power for the first PUSCH transmission is determined according to the first maximum output power value P_{CMAX,f,c,0} associated with the first PUSCH transmission, power control parameters associated with a first indicated TCI state associated with the first coresetPoolIndex value used for the first PUSCH transmission, and the first DCI; and
the transmit power for the second PUSCH transmission is determined according to the second maximum output power value P_{CMAX,f,c,1} associated with the second PUSCH transmission, power control parameters associated with a second indicated TCI state associated with the second coresetPoolIndex value used for the second PUSCH transmission, and the second DCI.

24. The UE of claim 16, wherein if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1,} and the first PUSCH transmission and the second PUSCH transmission are scheduled to be overlapped in the one slot, then:
a first candidate transmit power P_{PUSCH,b,f,c,0} for the first PUSCH transmission is determined according to the first maximum output power value P_{CMAX,f,c,0} associated with the first PUSCH transmission, power control parameters associated with a first indicated TCI state associated with the first coresetPoolIndex value used for the first PUSCH transmission, and the first DCI, and a second candidate transmit power P_{PUSCH,b,f,c,1} for the second PUSCH transmission is determined according to the second maximum output power value P_{CMAX,f,c,1} associated with the second PUSCH transmission, power control parameters associated with a second indicated TCI state associated with the second coresetPoolIndex value used for the second PUSCH transmission, and the second DCI,
if P_{PUSCH,b,f,c,0}+P_{PUSCH,b,f,c,1}≤P_{CMAX,f,c}, the transmit power for the first PUSCH transmission is the first candidate transmit power P_{PUSCH,b,f,c,0}, and the transmit power for the second PUSCH transmission is the second candidate transmit power P_{PUSCH,b,f,c,1}, and
if P_{PUSCH,b,f,c,0}+P_{PUSCH,b,f,c,1}>P_{CMAX,f,c}, the transmit power for the first PUSCH transmission and the transmit power for the second PUSCH transmission are determined according to at least one of:
the transmit power for the first PUSCH transmission is
$$min \{ {P}_{CMAX , f , c , 0} , \frac{{P}_{PUSCH , b , f , c , 0}}{{P}_{PUSCH , b , f , c , 0} + {P}_{PUSCH , b , f , c , 1}} \times {P}_{CMAX , f , c} \} ,$$
and the transmit power for the second PUSCH transmission is
$$min \{ {P}_{CMAX , f , c , 1} , \frac{{P}_{PUSCH , b , f , c , 1}}{{P}_{PUSCH , b , f , c , 0} + {P}_{PUSCH , b , f , c , 1}} \times {P}_{CMAX , f , c} \} ;$$
the transmit power for the first PUSCH transmission is
$$min \{ {P}_{CMAX , f , c , 0} , \frac{{P}_{CMAX , f , c , 0}}{{P}_{CMAX , f , c , 0} + {P}_{CMAX , f , c , 1}} \times {P}_{CMAX , f , c} \} ,$$
and the transmit power for the second PUSCH transmission is
$$min \{ {P}_{CMAX , f , c , 1} , \frac{{P}_{CMAX , f , c , 1}}{{P}_{CMAX , f , c , 0} + {P}_{CMAX , f , c , 1}} \times {P}_{CMAX , f , c} \} ;$$
if the first PUSCH transmission has a higher priority than the second PUSCH transmission, the transmit power for the first PUSCH transmission is P_{PUSCH,b,f,c,0} and the transmit power for the second PUSCH transmission is P_{CMAX,f,c}-P_{PUSCH,b,f,c,o}; and if the second PUSCH transmission has a higher priority than the first PUSCH transmission, the transmit power for the second PUSCH transmission is P_{PUSCH,b,f,c,1} and the transmit power for the first PUSCH transmission is P_{CMAX,f,c-}P_{PUSCH,b,f,c,1}; or
the transmit power for the first PUSCH transmission is bate*P_{CMAX,f,c} and the transmit power for the second PUSCH transmission is (1−bate)*P_{CMAX,f,c}, where, bate is a configured power allocation factor with the range of 0≤bate≤1.

25. The UE of claim 16, wherein the at least one processor is configured to cause the UE to report a power headroom report (PHR) including two or more power headroom (PH) values according to configured one or more maximum output power values.

26. The UE of claim 25, wherein if the configuration configures one maximum output power value P_{CMAX,f,c}, and a first PH and a second PH are included in the PHR:
when one of the first PUSCH transmission and the second PUSCH transmission is scheduled in the one slot, the first PH is calculated based on the scheduled PUSCH transmission, and the second PH is calculated based on a reference PUSCH transmission with the power control parameters associated with a coresetPoolIndex value different from the coresetPoolIndex value associated with the scheduled PUSCH transmission; and
when the first PUSCH transmission and the second PUSCH transmission are scheduled to be non-overlapped in the one slot, the first PH is calculated based on the one maximum output power value P_{CMAX,f,c}, power control parameters associated with a first indicated TCI state associated with the first coresetPoolIndex value used for the first PUSCH transmission, and the first DCI, and the second PH is calculated based on the one maximum output power value P_{CMAX,f,c}, power control parameters associated with a second indicated TCI state associated with the second coresetPoolIndex value used for the second PUSCH transmission, and the second DCI.

27. The UE of claim 25, wherein if the configuration configures one maximum output power value P_{CMAX,f,c}, and a first PH, a second PH and a third PH are included in the PHR:
when the first PUSCH transmission and the second PUSCH transmission are scheduled to be overlapped in the one slot, the first PH is calculated based on the one maximum output power value P_{CMAX,f,c}, power control parameters associated with a first indicated TCI state associated with the first coresetPoolIndex value used for the first PUSCH transmission, and the first DCI, the second PH is calculated based on the one maximum output power value P_{CMAX,f,c}, power control parameters associated with a second indicated TCI state associated with the second coresetPoolIndex value used for the second PUSCH transmission, and the second DCI, the third PH is calculated based on the one maximum output power value P_{CMAX,f,c}, power control parameters associated with a first indicated TCI state associated with the first coresetPoolIndex value used for the first PUSCH transmission, the first DCI, power control parameters associated with a second indicated TCI state associated with the second coresetPoolIndex value used for the second PUSCH transmission, and the second DCI.

28. The UE of claim 25, wherein, if the configuration configures a first maximum output power value P_{CMAX,f,c,0} associated with the first PUSCH transmission and a second maximum output power value P_{CMAX,f,c,1} associated with the second PUSCH transmission, and a first PH and a second PH are included in the PHR:
when one of the first PUSCH transmission and the second PUSCH transmission is scheduled in the one slot, the first PH is calculated based on one of the first and the second maximum output power values associated with the scheduled PUSCH transmission, power control parameters associated with an indicated TCI state associated with the coresetPoolIndex value associated with the scheduled PUSCH transmission, and the DCI scheduling the PUSCH 2 transmission, and the second PH is calculated based on the other of the first and the second maximum output power values assuming an allowed maximum power reduction MPR=0 dB, an additional maximum power reduction A-MPR=0, P-MPR=0 dB, an allowed operating band edge transmission power relaxation ΔTc=0 dB, and default power control parameters associated with a coresetPoolIndex value different from the coresetPoolIndex value associated with the scheduled PUSCH transmission; and
when the first PUSCH transmission and the second PUSCH transmission are scheduled to be non-overlapped in the one slot, the first PH is calculated based on the first maximum output power value P_{CMAX,f,c,0} associated with the first coresetPoolIndex value, power control parameters associated with a first indicated TCI state associated with the first coresetPoolIndex value used for the first PUSCH transmission, and the first DCI, and the second PH is calculated based on the second maximum output power value P_{CMAX,f,c,1} associated with the second coresetPoolIndex value, power control parameters associated with a second indicated TCI state associated with the second coresetPoolIndex value used for the second PUSCH transmission, and the second DCI.

29. The UE of claim 25, wherein, if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1}, and a first PH and a second PH are included in the PHR:
when one of the first PUSCH transmission and the second PUSCH transmission is scheduled in the one slot, the first PH is calculated based on one of the first and the second maximum output power values associated with the scheduled PUSCH transmission, power control parameters associated with an 3 indicated TCI state associated with the coresetPoolIndex value associated with the scheduled PUSCH transmission, and the DCI scheduling the PUSCH transmission, and the second PH is calculated based on the other of the first and the second maximum output power values assuming an allowed maximum power reduction MPR=0 dB, an additional maximum power reduction A-MPR=0, P-MPR=0 dB, an allowed operating band edge transmission power relaxation ΔTc=0 dB, and default power control parameters associated with a coresetPoolIndex value different from the coresetPoolIndex value associated with the scheduled PUSCH transmission; and
when the first PUSCH transmission and the second PUSCH transmission are scheduled to be non-overlapped in the one slot, the first PH is calculated based on the first maximum output power value P_{CMAX,f,c,0} associated with the first coresetPoolIndex value, power control parameters associated with a first indicated TCI state associated with the first coresetPoolIndex value used for the first PUSCH transmission, and the first DCI, and the second PH is calculated based on the second maximum output power value P_{CMAX,f,c,1} associated with the second coresetPoolIndex value, default power control parameters associated with a second indicated TCI state associated with the second coresetPoolIndex value 19 used for the second PUSCH transmission, and the second DCI.

30. The UE of claim 25, wherein if the configuration configures a first maximum output power value P_{CMAX,f,c,0} associated with the first PUSCH transmission, a second maximum output power value P_{CMAX,f,c,1} associated with the second PUSCH transmission, and an additional maximum output power value P_{CMAX,f,c}, which is smaller than P_{CMAX,f,c,0}+P_{CMAX,f,c,1} and larger than each of P_{CMAX,f,c,0} and P_{CMAX,f,c,1}, and a first PH, a second PH and a third PH are included in the PHR:
when the first PUSCH transmission and the second PUSCH transmission are scheduled to be overlapped in the one slot, the first PH is calculated based on the first maximum output power value P_{CMAX,f,c,0} associated with the first coresetPoolIndex value, power control parameters associated with a first indicated TCI state associated with the first coresetPoolIndex value used for the first PUSCH transmission, and the first DCI, the second PH is calculated based on the second maximum output power value P_{CMAX,f,c,1} associated with the second coresetPoolIndex value, power control parameters associated with a second indicated TCI state associated with the second coresetPoolIndex value used for the second PUSCH transmission, and the second DCI, and the third PH is calculated based on the additional maximum output power value P_{CMAX,f,c}, power control parameters associated with a first indicated TCI state associated with the first coresetPoolIndex value used for the first PUSCH transmission, the first DCI, power control parameters associated with a second indicated TCI state associated with the second coresetPoolIndex value used for the second PUSCH transmission, and the second DCI.

31. A processor for wireless communication, comprising:
at least one controller coupled with at least one memory and configured to cause the processor to:
receive a configuration to configure multiple maximum output power values in a bandwidth part (BWP) of a carrier of a serving cell based at least in part on a user equipment (UE) being indicated with a first Uplink (UL) or joint Transmission Configuration Indicator (TCI) state and a second UL or joint TCI state; and
determine transmit power for UL transmission according to the configured maximum output power values corresponding to at least one of the first UL or joint TCI state or the second UL or joint TCI state associated with the UL transmission.

32. The processor of claim 31, wherein the at least one controller is configured to cause the processor to receive a first Downlink Control Information (DCI) associated with a first coresetPoolIndex value and a second DCI associated with a second coresetPoolIndex value different from the first coresetPoolIndex value, in the BWP of the carrier of the serving cell, the first DCI scheduling a first physical uplink shared channel (PUSCH) transmission associated with the first coresetPoolIndex value and the second DCI scheduling a second PUSCH transmission associated with the second coresetPoolIndex value, the first PUSCH transmission and the second PUSCH transmission being in one slot.

33. The processor of claim 32, wherein the UL transmission comprises one or more of the first PUSCH transmission or the second PUSCH transmission.

34. A method performed by a user equipment (UE), the method comprising:
receiving a configuration to configure multiple maximum output power values in a bandwidth part (BWP) of a carrier of a serving cell based at least in part on the UE being indicated with a first Uplink (UL) or joint Transmission Configuration Indicator (TCI) state and a second UL or joint TCI state; and
determining transmit power for UL transmission according to the configured maximum output power values corresponding to at least one of the first UL or joint TCI state or the second UL or joint TCI state associated with the UL transmission.

35. A base unit for wireless communication, comprising:
at least one memory; and
at least one processor coupled with the at least one memory and configured to cause the base unit to:
transmit a configuration to configure multiple maximum output power values in a bandwidth part (BWP) of a carrier of a serving cell based at least in part on the UE being indicated with a first Uplink (UL) or joint Transmission Configuration Indicator (TCI) state and a second UL or joint TCI state.
